(19) United States
(12) Patent Application Publication
(10) Pub. No.: US 2021/0064064 A1
(43) Pub. Date: Mar. 4, 2021

(54) MANAGING AUTONOMOUS VEHICLES

(71) Applicant: Andrew DeLizio, Cypress, TX (US)

(72) Inventor: Andrew DeLizio, Cypress, TX (US)

(21) Appl. No.: 17/003,656

(22) Filed: Aug. 26, 2020

Related U.S. Application Data
(60) Provisional application No. 62/891,843, filed on Aug. 26, 2019.
(60) Provisional application No. 62/985,189, filed on Mar. 4, 2020.

(51) Int. Cl. G05D 1/10; G05D 1/00; G05D 1/02; B60W 60/00; B60W 30/09

(52) U.S. Cl. CPC G05D 1/106; G05D 1/0088; G05D 1/0094; G05D 1/0253; B60W 2554/4042; B60W 30/09; B60W 2556/45; B60W 2554/4041; B60W 2554/4044; B60W 60/0015

(57) ABSTRACT

Some embodiments include a method for providing control information to autonomous vehicles. The method may include receiving a video content stream over an electronic communication interface. The method may include identifying objects represented in the video content stream; determining information about the objects. The method may include transmitting, to one or more autonomous vehicles, one or more data streams including the information about the objects.

### RELATED APPLICATIONS

This application claims the priority benefit of Provisional U.S. Application No. 62/891,843 filed Aug. 26, 2019 and also claims the priority benefit of Provisional U.S. Application No. 62/985,189 filed Mar. 4, 2020.

### BACKGROUND

Autonomous vehicles are vehicles capable of sensing their environment and maneuvering without human input. Autonomous vehicles can include terrain-based vehicles (e.g., cars), watercraft, hovercraft, and aircraft. Autonomous vehicles can detect surroundings using a variety of techniques such as radar, lidar, GPS, odometry, and computer vision. Land-based autonomous vehicle guidance systems interpret sensory information to identify appropriate navigation paths, obstacles, and relevant signage. Land-based autonomous vehicles have control systems that can analyze sensory data to distinguish between different cars on the road, and guide themselves to desired destinations.

Among the potential benefits of autonomous vehicles (e.g., autonomous cars) are fewer traffic accidents, increased roadway capacity, reduced traffic congestion, and enhanced mobility for people. Autonomous cars can also relieve travelers from driving and navigation chores, freeing commuting hours with more time for leisure or work.

Autonomous vehicles will facilitate new business models of mobility as a service, including carsharing, e-hailing, ride hailing services, real-time ridesharing, and other services of the sharing economy.

### BRIEF DESCRIPTION OF DRAWINGS

FIG. 1 is a conceptual diagram illustrating an aerial vehicle configured to capture video content indicating objects on roadways, according some embodiments of the inventive subject matter.

FIG. 2 illustrates a video frame captured by an aerial vehicle, according to some embodiments.

FIG. 3 is a data flow diagram illustrating operations and data flow associated with an autonomous vehicle control system, according to some embodiments.

FIG. 4 is a block diagram illustrating components of an aerial autonomous vehicle, according to some embodiments of the inventive subject matter.

FIG. 5 is a block diagram illustrating a video processor, according to some embodiments of the inventive subject matter.

FIG. 6 is a block diagram illustrating a control data server, according to some embodiments of the inventive subject matter.

FIG. 7 is a flow diagram illustrating operations for controlling an aerial autonomous vehicle in capturing video content, according some embodiments.

FIG. 8 is a flow diagram illustrating operations for processing video content, according to some embodiments.

FIG. 9 is a flow diagram illustrating operations for processing and publishing object information, according to some embodiments of the inventive subject matter.

FIG. 10 is a flow diagram illustrating operations for utilizing a control stream in an autonomous vehicle, according some embodiments of the inventive subject matter.

FIG. 11 presents a block diagram illustrating an environment data structure for representing information related to objects in an environment and a conceptual diagram illustrating objects in an environment map.

FIG. 12 is a flow diagram illustrating operations for maneuvering an autonomous vehicle using an environment model.

FIG. 13 is a flow diagram illustrating a feedback loop between an autonomous vehicle and a control data server to confirm whether objects in the control stream have been perceived by autonomous vehicles.

FIG. 14 is a flow diagram illustrating operations for updating control data stream information based on feedback from one or more autonomous vehicles.

FIG. 15 is a block diagram illustrating components in a system for controlling autonomous vehicles, according to some embodiments of the inventive subject matter.

FIG. 16A is a block diagram illustrating control components of an autonomous vehicle, according to some embodiments of the inventive subject matter.

FIG. 16B is a block diagram illustrating operations for driving and guiding an autonomous vehicle, according to some embodiments.

FIG. 17 is a block diagram of a ride service controller, according to some embodiments of the inventive subject matter.

FIG. 18 is a block diagram of a fleet controller, according to some embodiments of the inventive subject matter.

FIG. 19 is a flow diagram illustrating operations for replenishing resources of an autonomous vehicle, according some embodiments of the inventive subject matter.

FIG. 20 is a flow diagram illustrating operations for processing resource requests, according to some embodiments.

FIG. 21 is a flow diagram illustrating operations for an autonomous vehicle requesting and receiving resources, according to some embodiments of the inventive subject matter.

FIG. 22 is a conceptual diagram illustrating stages related to autonomous vehicles unloading passengers in an unloading zone.

FIGS. 23 and 24 are a conceptual diagram illustrating stages related to autonomous vehicles unloading passengers in an unloading zone.

FIG. 25 is a flow diagram illustrating operations controlling an autonomous vehicle in an unloading zone, according to some embodiments of the inventive subject matter.

FIG. 26 is a conceptual diagram illustrating an autonomous vehicle system configured for video capture.

FIG. 27 is a flow diagram illustrating operations for monitoring the communication channel and dispatching an autonomous vehicle system, according to some embodiments.

FIG. 28 is a flow diagram illustrating operations by which the autonomous vehicle system deploys to a location to capture video, according to some embodiments of the inventive subject matter.

### INTRODUCTION TO SOME EMBODIMENTS

As autonomous vehicle guidance systems evolve, they will control vehicles without any human input or presence. Embodiments of the inventive subject matter provide autonomous vehicles with information about obstacles, traffic, objects, and physical phenomena. In the following discussion, the term “object” can include wind, flowing water, fog, traffic, animals, and other phenomena that may cause autonomous vehicles to change the driving characteristics. Autonomous vehicles can use this information to safely maneuver about. In some embodiments, one or more aerial balloons are equipped with video equipment that captures video content of a relatively large geographic area. The balloons may transmit the video content to one or more computers that process the video content to identify and locate objects, obstacles, and physical phenomena. The information about the objects, obstacles, and physical phenomena is published to autonomous vehicles. The autonomous vehicles can use this information along with information from their onboard sensors to create a more informed model of their surroundings.

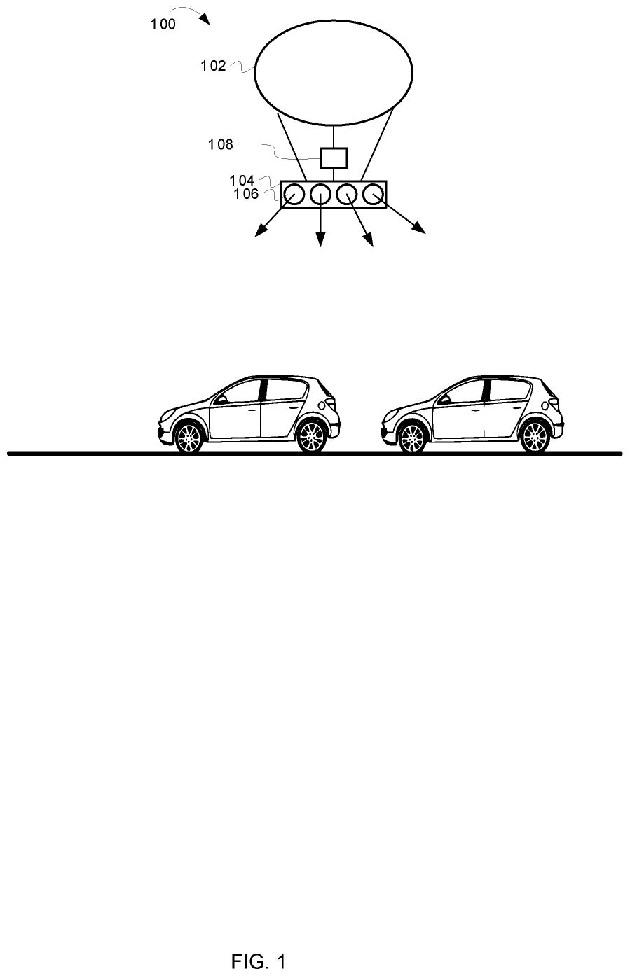

FIG. 1 is a conceptual diagram illustrating an aerial vehicle configured to capture video content indicating objects on roadways, according some embodiments of the inventive subject matter. In FIG. 1, an aerial vehicle 100 includes a balloon 102, cargo container 104, and video capture array 106. In some embodiments, the balloon 102 contains one or more gases lighter than ambient air to provide lift to the vehicle 100. The vehicle 100 includes a device 108 for supplying additional gas to the balloon 102. In some embodiments, the vehicle 100 includes material that causes the balloon to gain buoyancy from solar radiation. In some embodiments, the balloon 102 may contain lighter-than-air gas. The device 108 may include a burner that supplies hot air to the balloon 102. In yet other embodiments, the balloon 102 is sealed and the vehicle 100 does not include any device for supplying gas or hot air. The cargo container 104 can be any suitable container for storing electronics (e.g., circuit boards, processors, microchips, batteries, wiring, etc.) that perform the operations and functionality described herein.

The video capture array 106 can include one or more cameras capable of capturing still images, streaming video, or any other suitable form of video content over a large geographic area. In one embodiment, the video capture array 106 includes 368 cameras capable of capturing 5 million pixels each to create an image of about 1.8 billion pixels. Video may be collected at a variable frame-rates per second, with the resulting data output averaging several gigabytes of video output per minute. In some embodiments the video capture array includes a composite focal plane array (CFPA) assembly of 368 overlapping FPAs, imaging a wide persistent area at 10 Hz. Each focal plane array can provide high-resolution imagery that can be combined with neighboring focal plane arrays to create video windows, detect and track moving vehicles, reach back into the forensic archive, and generate three-dimensional models. However, other embodiments may utilize any suitable number and arrangement of video devices having suitable capabilities (e.g., resolution, frame rate, etc.).

Although FIG. 1 shows the aerial vehicle 100 including a balloon, other embodiments may include other components for staying aloft. For example, the aerial vehicle may include one or more rotors, one or more wings, one or more jets, etc. As such, in some embodiments the aerial vehicle can be a fixed wing aircraft (such as an airplane), a rotor wing aircraft (such as a helicopter, quadcopter, etc.), or other suitable aircraft.

In some embodiments, the video capture array is included in a satellite that orbits Earth instead of being included in an aircraft that flies or otherwise remains aloft within the Earth's atmosphere. Irrespective of how the aerial vehicle remains aloft and whether it remains within the Earth's atmosphere, the aerial vehicle can include the video capture array and other components for performing the functionalities described herein.

In some embodiments, the video capture array may be mounted on Earth (such as on a tower, pole, building, etc.). Earth-mounted video capture arrays can function similarly to aircraft and satellite mounted video capture arrays. In some embodiments, metadata associated with captured video content differs depending on where the video capture array is mounted (such as on a balloon, satellite, Earth-based structure, etc.).

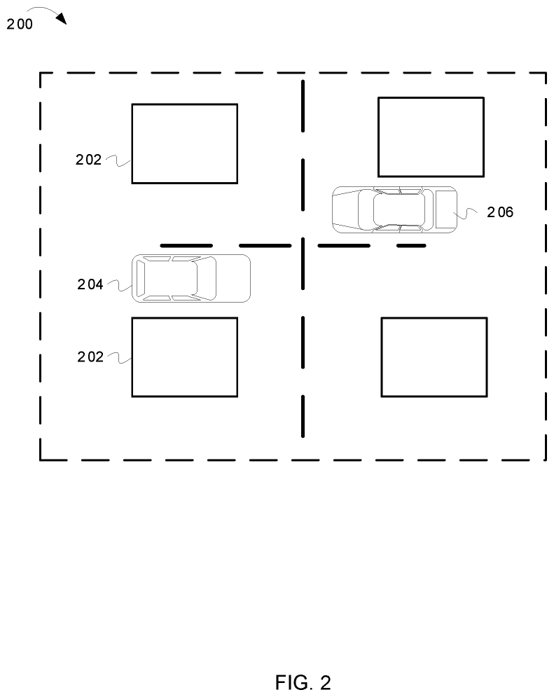

FIG. 2 illustrates a video frame captured by a video capture array of an aerial vehicle, according to some embodiments. In FIG. 2, a video capture array of an aerial vehicle has captured a video frame 200. The video frame 200 includes buildings 202 and vehicles 204 & 206. The aerial vehicle can itself process the video frame to identify objects (e.g., the buildings 202 and vehicles 204 & 206), or the aerial vehicle can transmit the video frame 200 for processing by a remote video processing system.

In some embodiments, the aerial vehicle and/or the video capture array includes components that capture and provide metadata with the video frame 200. The metadata can include information indicating where the frame is on earth (e.g., coordinates of each corner of the frame, a plurality of geographic coordinates associated with points in the frame, etc.). The metadata can also include: information about the aerial vehicle's position and orientation relative to earth, time of day, date, information about the video equipment (e.g., brand, specs, video capture rate, resolution, etc.), and any other information that may be useful in identifying objects and indicating their location on earth.

The video frame 200 (or motion video) can cover a relatively large geographic area (e.g., 25 square miles or more). In some embodiments, the video frame 200 is a composite image created from a plurality of images captured by a CFPA. Objects in the image can be any physical objects on earth. The frame 200 can also include any physical phenomena occurring on earth, such as various weather conditions, light conditions, flowing water, etc.

Some embodiments may capture motion video of moving objects, physical phenomena, etc. The motion video may be a composite of multiple motion videos captured by the CFPA.

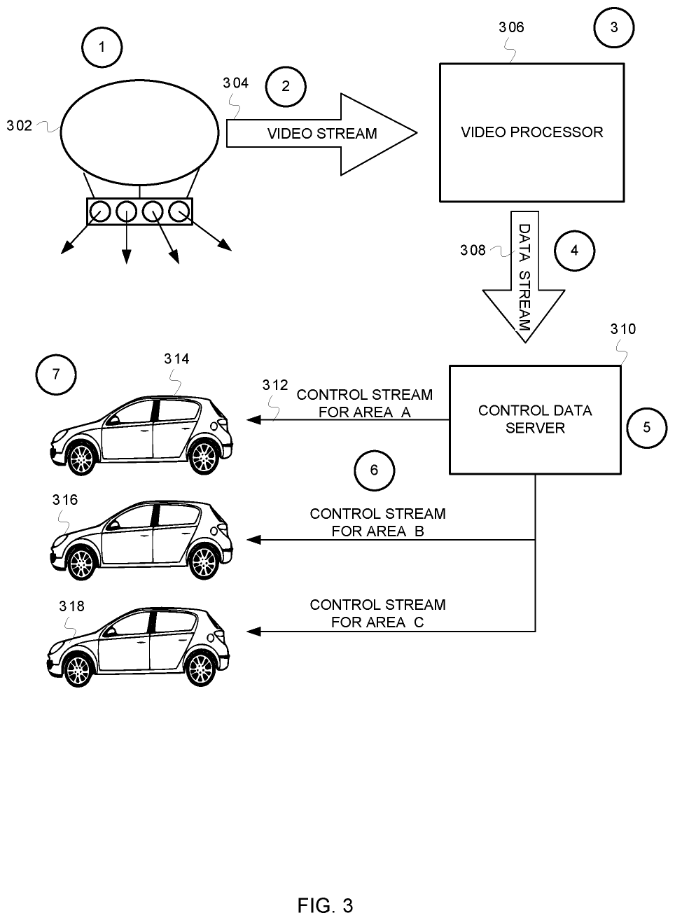

In some embodiments, as an aerial vehicle captures video content, the aerial vehicle transmits the video content to a remote video processor to identify objects in the video and to publish control data to autonomous vehicles. FIG. 3 further describes how some embodiments perform such a process.

FIG. 3 is a data flow diagram illustrating operations and data flow associated with an autonomous vehicle control system, according to some embodiments. In FIG. 3, the operations and data flow occur in seven stages. During stage 1, an aerial vehicle 302 includes a video capture system that captures video content over a geographic area. The video content may capture images of streets, buildings, land-based vehicles, objects, physical phenomenon, metadata, and any other information useful in identifying objects in the video content. The aerial vehicle's video capture system can also determine metadata associated with the video content. The metadata can include any information for determining time, geographic location, altitude, orientation, or any other discernable information describing objects and video captured by the aerial vehicle's video capture system.

During stage 2, the aerial vehicle transmits one or more video streams 304 over one or more network interface components to a video processor 306. In some embodiments, the video stream 304 includes video content and metadata. The video stream 304 also can include other information, such as information related to the aerial vehicle 302, the aerial vehicle's video capture system (e.g., a CFPA), resources available on the aerial vehicle 302, and/or any other data relevant to the aerial vehicle 302 and the process for delivering control information to autonomous vehicles. Data flow continues at stage 3.

During stage 3, the video processor 306 processes the video content to identify objects, physical phenomena, conditions, etc. represented in the video content. Some embodiments utilize the metadata in the process of identifying objects etc. Any suitable techniques for identifying and locating objects in video content may be utilized by the video processor 306. In some embodiments, the video processor includes an object detection framework (such as the Viola Jones object detection framework). In some embodiments, the video processor 306 processes motion video of moving objects (e.g., in contrast to a frame by frame analysis of the video content). For videos of moving objects, some embodiments utilize use tracking algorithms such as the Kanade-Lucas-Tomasi (KLT) algorithm to track object movement between frames. Embodiments can utilize any suitable technique for identifying objects, tracking objections, and otherwise determining object size and location relative to the earth, landmarks, objects, and vehicles.

During stage 4, the video processor 306 transmits a data stream 308 to a control data server 310. The data stream 308 can include information identifying objects, their geographic location, direction of movement, size, and other discernible information describing the objects. In some embodiments, the video processor 306 transmits the data stream 308 over a very high-speed communications network. In some embodiments, the communications network can include 5G technology, fiber-optic technology, or any other high-speed telecommunications technology.

During stage 5, the control data server 310 creates data streams relevant to each of a plurality of land-based autonomous vehicles. The data streams may pertain to a specific geographic area and can include control data identifying objects and indicating their location, direction, speed, size, and/or any other discernable information about the objects. The data streams may include similar information for physical phenomena. The control data server 310 can utilize a compact data format for representing control data suitable for publication to a plurality of land-based autonomous vehicles. The control data can include any suitable information about objects, physical phenomena, etc. in a specific geographic area. The control data server 310 can publish the control data to autonomous vehicles that subscribe to receive control data for a specified geographic area.

In some embodiments, the control data server 310 creates and publishes a stream of control data associated with a relatively large area (e.g., the area covered by the information contained in the data stream 308). Each land-based autonomous vehicle that receives the stream of control data can utilize whatever portions of the control data that are relevant to the land-based autonomous vehicle.

During stage 6, the control data server 310 publishes a plurality of different control streams to a plurality of land-based autonomous vehicles. As shown, the control data server 310 publishes a control stream 312 associated with a first geographic area (referred to in FIG. 3 as “AREA A”) to land-based autonomous vehicle 314. The control data server 310 also publishes a separate control stream for “AREA B” to the land-based autonomous vehicle 316, and yet a separate control stream for “AREA C” to the land-based autonomous vehicle 318.

During stage 7, the autonomous vehicles 314, 316, 318 utilize the control streams in modeling their environment. In some embodiments, the autonomous vehicles create a model of their environment based on data from their local sensors and based on the control data. In some embodiments, the autonomous vehicles model their environment based exclusively on the control data.

In some embodiments, the video stream may not originate from an aerial vehicle. For example, in some embodiments, the control data server may receive the video stream from a terrestrial component (e.g., a camera mounted on a pole, building, etc.), outer-space vehicle (e.g., a satellite), etc. In some embodiments, autonomous vehicles receiving control streams may include land-based vehicles, aerial vehicles, and space-based vehicles.

This description continues with a description of various components used by some embodiments of the inventive subject matter.

### Components of Some Embodiments

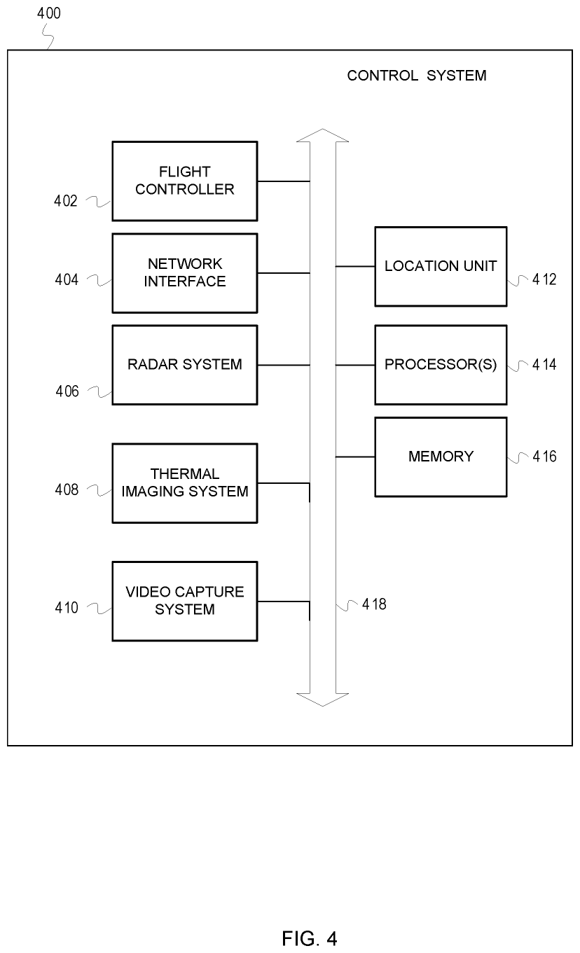

FIG. 4 is a block diagram illustrating components of an aerial autonomous vehicle, according to some embodiments of the inventive subject matter. In some embodiments, the aerial autonomous vehicle includes a balloon or other gas container for keeping the vehicle aloft. The aerial vehicle can include a solar balloon. The aerial vehicle can include any suitable propulsion system, solar arrays for power, and any other components to remain aloft indefinitely. In FIG. 4, an aerial control system 400 includes a flight controller 402, network interface 404, radar system 406, thermal imaging system 408, and video capture system 410. The control system 400 also includes a location unit 412, one or more processors 414, and one or more memory devices 416. These components are connected to a bus 418.

The flight controller 402 can control flight operations of the aerial autonomous vehicle. The flight operations can include maneuvering the aerial vehicle according to any suitable flight plan or operational plan. The network interface 404 can transmit and receive electronic communications over any suitable wireless and wired communication network. The radar system 406 can utilize any suitable radar for sensing objects that may be in the vehicle's flight path. Likewise, the thermal imaging system can utilize any suitable thermal imaging technology to detect objects in the vehicle's flight path.

The video capture system 410 can include any suitable video capture equipment, such as one or more focal plane arrays including a plurality of cameras, a composite plane array including a plurality of cameras. The video capture system can capture still video images, motion video, and audio data. The cameras and devices included in the video capture system 410 can employ any suitable video technology, such as encoding formats (JPEG, MPEG, etc.), frame rates, lighting filters, etc.

The location unit 412 can include technology for locating the aerial autonomous vehicle relative to the earth or any other fixed point in space. For example, the location unit 412 may the global positioning system or other satellite-based or earth-based location system that can be used to determine geographic positions relative to the earth. GPS data also indicates altitude, orientation, and other location-related information of the aerial autonomous vehicle. In some embodiments, the video capture system 410 works in concert with the location unit 412 to determine location-related metadata associated with the vehicle itself, the video capture system itself, images, objects within the images, etc.

The one or more processors 414 can include any suitable programmable microprocessor technology. The one or more memory devices 416 can include solid-state semiconductor memory, rotating magnetic disk memory, or any other suitable memory technology. In some embodiments, the components shown in FIG. 4 include computer-executable program code that executes on the one or more processors 414. Such computer-executable program code may sometimes partially or wholly reside in the one or more memory devices 416.

The aerial control system 400 may include different components for satellites, fixed wing aircraft, rotor wing aircraft, etc.

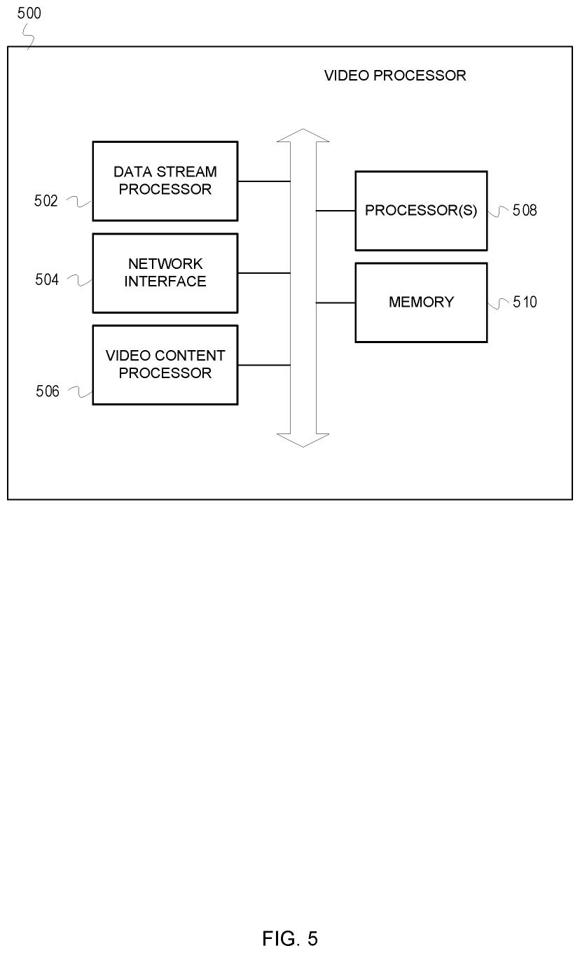

FIG. 5 is a block diagram illustrating a video processor, according to some embodiments of the inventive subject matter. In FIG. 5, a video processor 500 includes a data stream processor 502, network interface 504, the video content processor 506, one or more processors 508, and one or more memory devices 510.

Embodiments of the video processor receive a video stream from an aerial autonomous vehicle over the network interface 504. The video content processor 506 identifies, locates, and/or tracks objects in the video stream received from the aerial autonomous vehicle. Any suitable techniques for identifying and locating objects in the video stream may be utilized by the video content 506. In some embodiments, the video processor includes an object detection framework (Viola Jones object detection framework). In some embodiments, the video processor 306 processes motion video of moving objects (e.g., in contrast to a frame by frame analysis of the video content). For videos of moving objects, some embodiments utilize use tracking algorithms such as the Kanade-Lucas-Tomasi (KLT) algorithm to track object movement between frames. Embodiments can utilize any suitable technique for identifying objects, tracking objections, and otherwise determining object size and location relative to the earth, landmarks, objects, and vehicles.

After the video processor 500 identifies, locates, tracks, and/or otherwise discerns information about objects in the video content, the data stream processor 502 creates a data stream including such information. The data stream can be represented in any suitable data format. The data stream processor 502 transmits the data stream to a control data server over the network interface 504.

The one or more processors 508 can include any suitable programmable microprocessor technology. The one or more memory devices 510 can include solid-state semiconductor memory, rotating magnetic disk memory, or any other suitable memory technology. In some embodiments, the components shown in FIG. 5 include computer-executable program code that executes on the one or more processors 508. Such computer-executable program code may sometimes partially or wholly reside in the one or more memory devices 510.

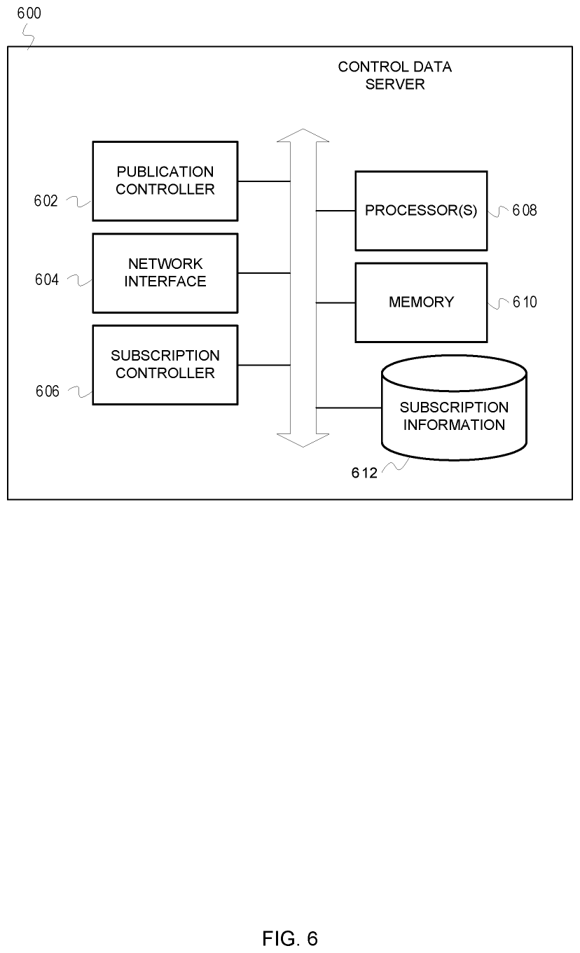

FIG. 6 is a block diagram illustrating a control data server, according to some embodiments of the inventive subject matter. In FIG. 6, a control data server 600 includes a publication controller 602, network interface 604, subscription controller 606, one or more processors 608, one or more memory devices 610, and subscription information store 612. In some embodiments, the video processor 500 resides within the control data server.

The publication controller 602 can publish control streams to autonomous vehicles that subscribe to receive them. For example, a particular control stream may include object information for a given geographic area. One or more autonomous vehicles may subscribe to receive the control stream for the given geographic area. As an autonomous vehicle leaves the geographic area, its subscription to the current control stream may lapse and it may subscribe to a different control stream for a different geographic area. The subscription information store 612 stores the subscription information. The subscription information can include network addresses and/or other suitable identifiers indicating where the control streams are to be sent.

The network interface 604 includes any suitable networking technology capable of wired or wireless transmission of data.

The subscription controller 606 can process subscription requests from autonomous vehicles seeking to receive control streams from the control data server 600. The subscription information is stored in the subscription information store 612.

The one or more processors 608 can include any suitable programmable microprocessor technology. The one or more memory devices 510 can include solid-state semiconductor memory, rotating magnetic disk memory, or any other suitable memory technology. In some embodiments, the components shown in FIG. 6 include computer-executable program code that executes on the one or more processors 608. Such computer-executable program code may sometimes partially or wholly reside in the one or more memory devices 610.

### Operations of Some Embodiments

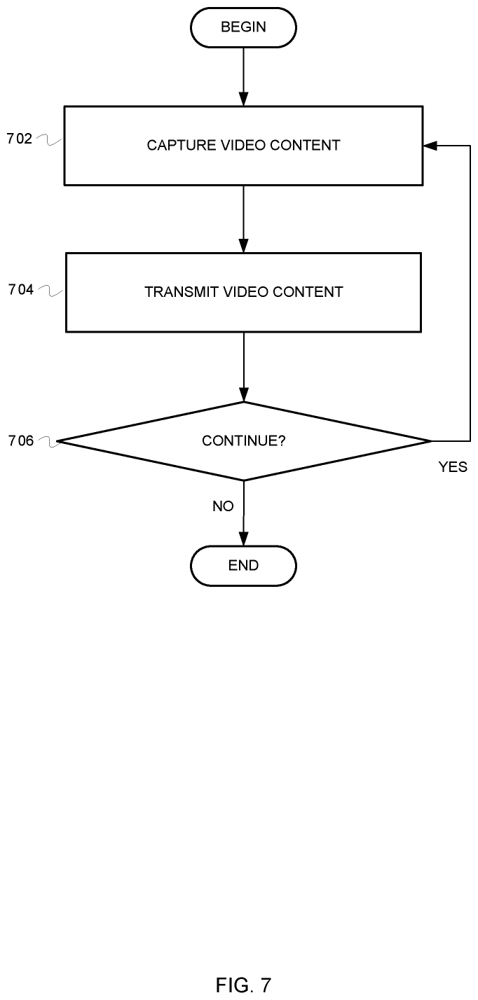

The following discussion describes operations for capturing video in an aerial autonomous vehicle, transmitting the video for further video processing, and publishing control data for use by autonomous vehicles. FIG. 7 describes capturing video.

FIG. 7 is a flow diagram illustrating operations for controlling an aerial autonomous vehicle in capturing video content, according some embodiments. In some embodiments, the aerial autonomous vehicle is a lighter-than-air autonomous vehicle. In some embodiments, the aerial autonomous vehicle includes a video capture system that performs the operations shown in FIG. 7. In FIG. 7, a flow begins at block 702.

At block 702, an aerial autonomous vehicle's video capture system captures video content. In some embodiments, the video content includes images from a geographic area on earth. The video content may be derived based on photography, thermal imaging, infrared imaging, or any other suitable technique for capturing data for imaging. In some embodiments, the aerial autonomous vehicle also may capture radar content for identifying airborne and terrestrial vehicles and objects. The flow continues at block 704.

At block 704, the aerial autonomous vehicle transmits the video content for image processing. In some embodiments, the image processing includes identifying, tracking, and/or discerning information about objects represented in the video content. The flow continues at block 706.

At block 706, the aerial autonomous vehicle determines whether to continue capturing video content. If the process ceases to continue, the flow ends. Otherwise, the flow continues at block 702.

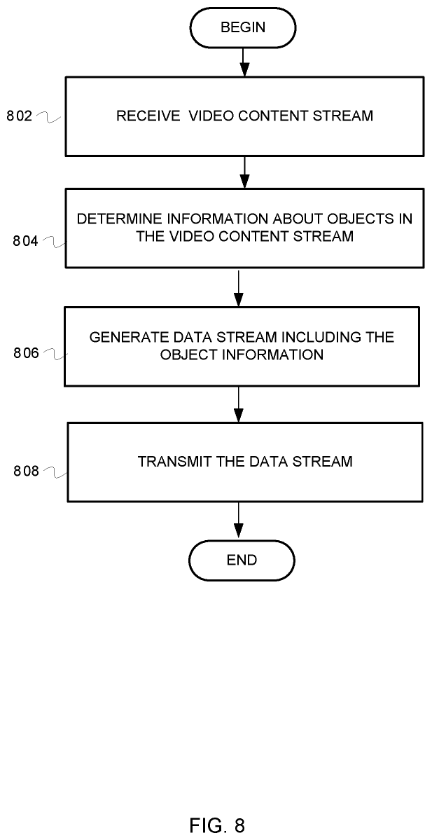

As noted in FIG. 7, the video content is transmitted to a video processor. FIG. 8 describes how some embodiments process the video content.

FIG. 8 is a flow diagram illustrating operations for processing video content, according to some embodiments. In some embodiments, the operations shown in FIG. 8 are performed by a video processor. In FIG. 8, a flow 800 begins at block 802.

At block 802, a video processor receives a video content stream that was captured by an aerial autonomous vehicle. The flow continues at block 804.

At block 804, the video processor determines information about objects in the video content stream. For example, the video processor may identify objects (e.g., determine that an object is a vehicle, person, etc.), track object movement, determine object location, determine object speed, and/or discern any other information about objects in the video content based on the video content itself and metadata associated with the video content. The flow continues at block 806.

At block 806, the video processor generates a data stream including the object information. The data stream can be in any suitable data format. The flow continues at block 808.

At block 808, the video processor transmits the data stream for further processing and publication to autonomous vehicles. In some embodiments, the video processor transmits the data stream to a control data server for further processing and publication to land-based autonomous vehicles that have subscribed to receive particular control streams. From block 808, the flow ends.

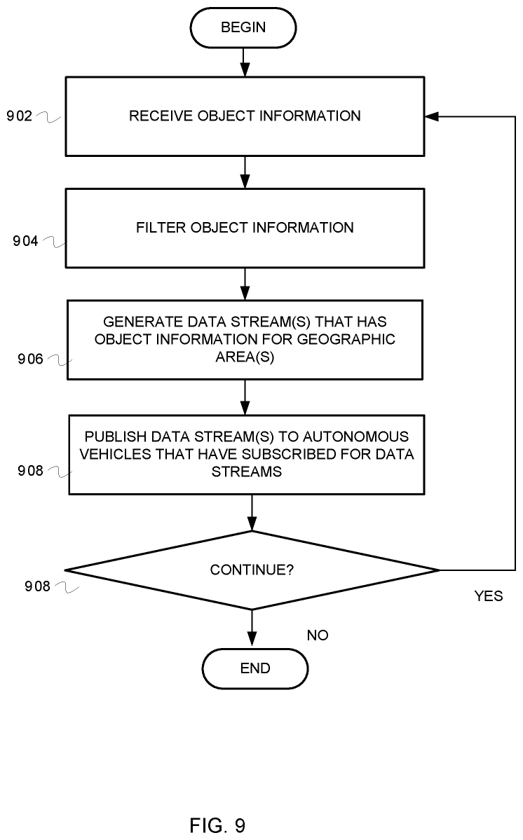

FIG. 9 is a flow diagram illustrating operations for processing and publishing object information, according to some embodiments of the inventive subject matter. In some embodiments, operations shown in FIG. 9 are performed by a control data server. In FIG. 9, a flow 900 begins at block 902.

At block 902, a control data server receives object information from the video processor. In some embodiments, the object information can include information identifying objects, their geographic location, size, direction, speed and other information discernible by the video capture system (see discussion above) and the video processor. The flow continues at block 904.

At block 904, the control data server filters the object information. In some embodiments, the control data server filters the object information based on geographic areas. For example, all object information associated with a particular geographic area is indexed or otherwise stored as being associated with the geographic area. In some embodiments, the object information is filtered differently. For example, some embodiments can filter object information based on other criteria, such as altitude (e.g., for use by aerial autonomous vehicles), proximity to a fixed or mobile reference point (e.g., a landmark, a non-stationary object such as a land-based autonomous vehicle, etc.), temperature, or other physical phenomena (e.g., associated with rain, wind, or other physical phenomena). The flow continues at block 906.

At block 906, the control data server generates one or more data streams that each includes object information. These data streams including object information may be referred to herein as control streams. The control streams can be represented in any suitable data format. The flow continues at block 908.

At block 908, the control data server publishes one or more control streams to autonomous vehicles that have subscribed for the control streams. In some embodiments, autonomous vehicles subscribe to particular control stream for particular geographic areas. For example, a land-based autonomous vehicle operating in a particular ZIP Code may subscribe to receive a control stream that includes information about objects in that ZIP Code. In some embodiments, autonomous vehicles may subscribe to data streams based on other criteria. For example, an autonomous vehicle may subscribe for a control stream associated with a rainy area. As another example, an aerial autonomous vehicle may subscribe to receive a control stream for an altitude range over a given geographic area. The flow continues at block 910.

At block 910, the control data server determines whether there is additional object information to process. If there is additional object information to process, the flow continues at block 902. If there is no additional object information to process, the flow ends.

This description continues with a discussion about how autonomous vehicles may use control streams to maneuver about.

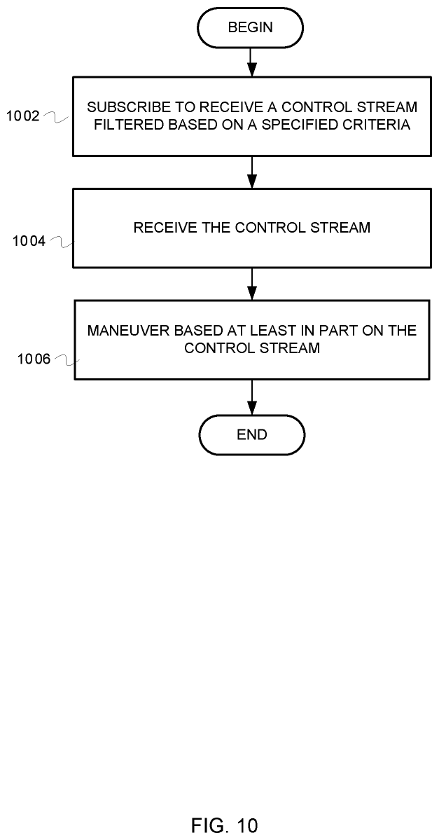

FIG. 10 is a flow diagram illustrating operations for utilizing a control stream in an autonomous vehicle, according some embodiments of the inventive subject matter. In FIG. 10, a flow 1000 begins at block 1002. At block 1002, an autonomous vehicle subscribes to receive a control stream that has been filtered based on one or more criteria. For example, a land-based autonomous vehicle may subscribe for a control stream associated with a specific geographic area. The flow continues at block 1004.

At block 1004, the autonomous vehicle receives the control stream. In some embodiments, the autonomous vehicle receives the control stream over a telecommunications network (e.g., a 5G network) and stores it in a memory device. The flow continues at block 1006.

At block 1006, the autonomous vehicle utilizes the control stream to maneuver. For example, the autonomous vehicle's driving and guidance system may utilize the control stream to model the vehicle's environment. For example, the autonomous vehicle's driving and guidance system may maintain a data structure or other information that indicates obstacles, road conditions, objects, and other physical phenomena that affect maneuvering decisions. In some embodiments, the driving and guidance system creates an environment map indicating objects and associated information (e.g., speed, direction, size, etc.) and any physical conditions that affect the maneuvering process. From block 1006, the flow ends.

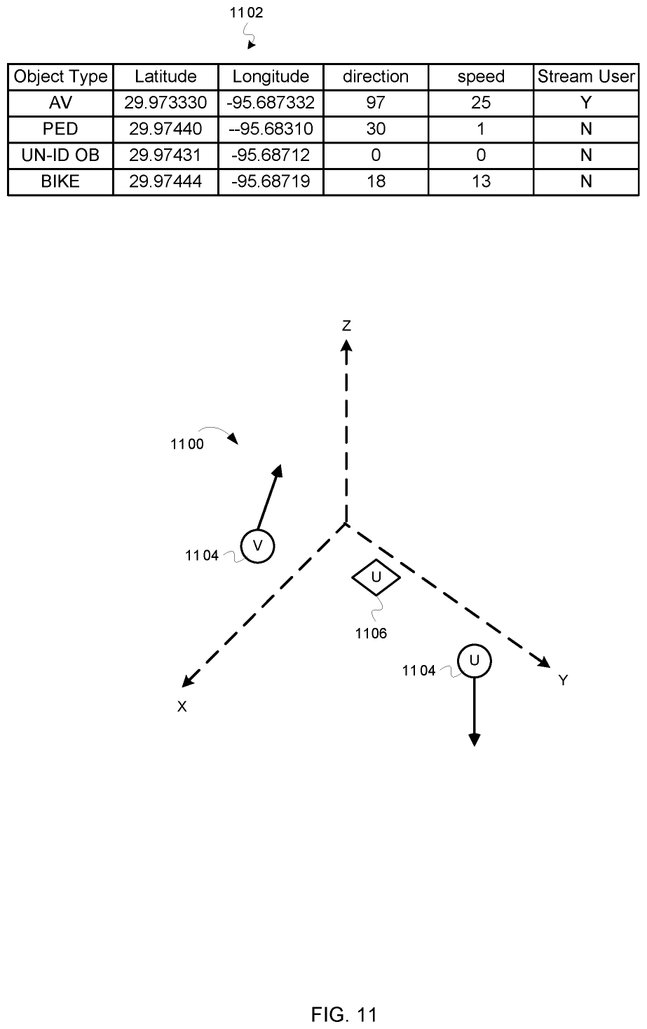

FIG. 11 presents a block diagram illustrating an environment data structure for representing information related to objects in an environment and a conceptual diagram illustrating objects in an environment map. In FIG. 11, an environment data structure 1102 includes columns representing the following object attributes: object type, latitude, longitude, direction, speed, control stream user. A first row of the data structure 1102 includes data related to an autonomous vehicle at latitude 29.973330, longitude −95.687332, headed direction 97, at speed 25. The first row also indicates that the autonomous vehicle is utilizing a control stream.

Data in the environment data structure 1102 may be received as part of a control stream. In some embodiments, the control stream includes environment data structures relevant to a given autonomous vehicle. In some embodiments, the control stream includes information about objects, and the autonomous vehicle creates and maintains the environment data structure.

As shown in the first column of data structure 1102, object types can include autonomous vehicles, pedestrians, unidentified objects, bicycles, and any other suitable object type. The latitude and longitude columns can indicate latitudes and longitudes associated with objects. In some embodiments, other indicia may be used to indicate an object's position on the Earth's surface or position relative to the earth. The direction can be indicated by any suitable indicia indicating relative direction of movement (if any) of the object. Speed can indicate speed of the object. The stream user column indicates whether the object utilizes a control stream. In FIG. 11, the object represented in the first row does utilize a control stream. However, the other objects represented in the remaining rows do not utilize control streams.

In some embodiments, data structures representing information about objects can include additional information that may be used to predict one or more object's movement, direction, speed, or other behavior. In some embodiments, autonomous vehicles store data structures 1102 two facilitate their maneuvering processes. In some embodiments, a control data server may generate data structures 1102 and disseminate them to autonomous vehicles.

FIG. 11 also includes an environment map 1100. The environment map 1100 represents objects in three-dimensional space. The environment map 1100 includes autonomous vehicles 1104 and an unidentified object 1106. In some embodiments, an object's type determines its shape in the map 1100. For example, the autonomous vehicles appear as spheres. As another example, the unidentified object 1106 appears as a diamond. Vectors emanating from the objects 1104 indicate direction and speed. The object 1106 has no vector because it is not moving. Any suitable indicia may be used to visualize data associated with objects. In some embodiments, autonomous vehicles and other components present environmental maps 1100 on video output devices. In other embodiments, environment maps are not presented on video output devices, but are instead use to convey data (similar to the data structure 1102). In some embodiments, the environment map can be built based on data stored in a data structure 1102.

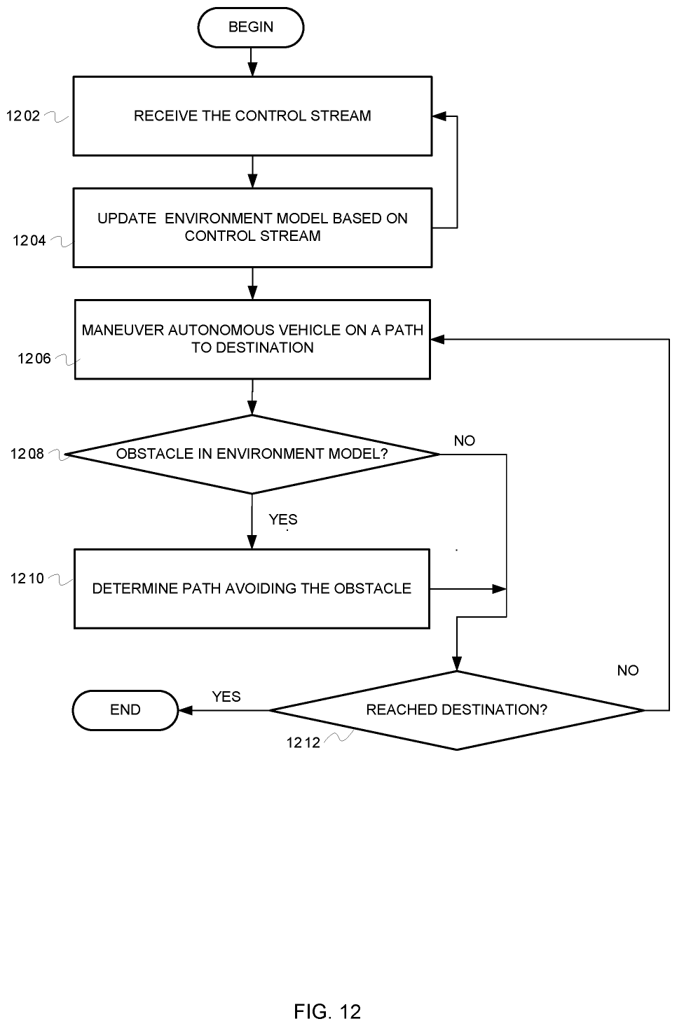

FIG. 12 is a flow diagram illustrating operations for maneuvering an autonomous vehicle using an environment model. The environment model may be represented as an environment map (e.g., see 1100), environment data structure (e.g., see 1102), or any other suitable information device. In FIG. 12, a flow diagram 1200 begins at block 1202.

At block 1202, an autonomous vehicle receives a control stream. In some embodiments, the autonomous vehicle receives the control stream over a telecommunications network (e.g., a 5G network) and stores it in a memory device. The flow continues at block 1204.

At block 1204, the autonomous vehicle updates an environmental model based on information in the control stream. For example, the autonomous vehicle may update an environment data structure to indicate newly perceived objects and/or update information about objects already represented in the environment data structure. For newly perceived objects, the autonomous vehicle may create a new row in the environment data structure, and add information about the newly perceived object. When updating an existing row, the autonomous vehicle may modify one or more columns with new information about the object. From block 1204, the flow continuously loops back to 1202 until the flow otherwise ends. Additionally, from block 1204, the flow continues at block 1206.

At block 1206, the autonomous vehicle maneuvers on a path toward a destination. The flow continues at block 1208.

At block 1208, the autonomous vehicle determines whether the environment model indicates an object that may cause the autonomous vehicle to deviate its path, speed, or other driving characteristics. In some embodiments, the autonomous vehicle includes a driving and guidance system that continuously monitors the environment model for indications that the autonomous vehicle will soon encounter an object. In some embodiments, the autonomous vehicle's driving and guidance system also utilizes onboard sensors (e.g., cameras, lidar, etc.) to detect objects that may require a modification to path or driving characteristics. If the environment model indicates an object, the flow continues at block 1210. Otherwise, the flow continues at block 1212.

At block 1210, the autonomous vehicle determines a path avoiding the object. In some embodiments, the autonomous vehicle may rely (in whole or part) on information represented in the environment model to determine a path avoiding the object. In some embodiments, the autonomous vehicle may rely (in whole or part) on information gleaned from local onboard sensors to determine a path avoiding the object. In some embodiments, an obstacle may not necessitate a change in path but instead a change to one or more driving characteristics such as speed, acceleration, deceleration, altitude, trim level (marine), ride height (adjustable suspension systems), etc. The flow continues at block 1212.

At block 1212, the autonomous vehicle's driving and guidance system determines whether it has reached its destination. If not, the flow loops back to 1206. If so, the flow ends.

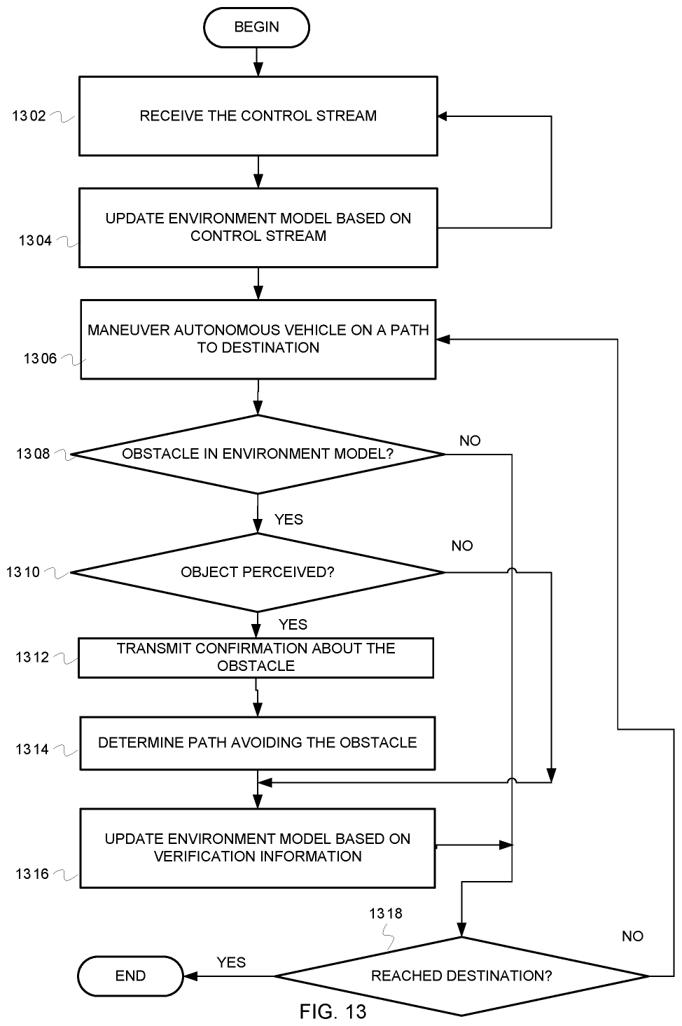

FIG. 13 is a flow diagram illustrating a feedback loop between an autonomous vehicle and a control data server to confirm whether objects in the control stream have been perceived by autonomous vehicles. In some embodiments, the autonomous vehicle maintains an environment model including information about objects. The environment model may be represented as an environment map (e.g., see 1100), environment data structure (e.g., see 1102), or any other suitable information device. In some embodiments, the control data server maintains environment model. In some embodiments, both the control data server and the autonomous vehicle maintain environment models. In FIG. 13, a flow diagram 1300 begins at block 1302.

At block 1302, an autonomous vehicle receives a control stream. In some embodiments, the autonomous vehicle receives the control stream over a telecommunications network (e.g., a 5G network) and stores it in a memory device. The flow continues at block 1204.

At block 1304, the autonomous vehicle updates an environmental model based on information in the control stream. For example, the autonomous vehicle may update an environment data structure to indicate newly perceived objects and/or update information about objects already represented in the environment data structure. For newly perceived objects, the autonomous vehicle may create a new row in the environment data structure, and add all known information about an object. When updating an existing row, the autonomous vehicle may modify one or more columns with new information. From block 1304, the flow continuously loops back to 1302 until the flow otherwise ends. Additionally, from block 1304, the flow continues at block 1306.

At block 1306, the autonomous vehicle maneuvers on a path toward a destination. The flow continues at block 1308.

At block 1308, the autonomous vehicle determines whether the environment model indicates an object that may cause the autonomous vehicle to modify its path, speed, or other driving characteristics. In some embodiments, the autonomous vehicle includes a driving and guidance system that continuously monitors the environment model for indications that the autonomous vehicle will soon encounter an object. In some embodiments, the autonomous vehicle's driving and guidance system also utilizes onboard sensors (e.g., cameras, lidar, etc.) to detect objects that may require deviations to path and/or driving characteristics. As a result, an autonomous vehicle can verify information about an object with its own sensors and functionality. If the environment model indicates an obstacle, the flow continues at block 1310. If not, the flow continues at block 1318.

At block 1310, the autonomous vehicle determines whether an object in the environment model was perceived by the autonomous vehicle itself. In some embodiments, the autonomous vehicle's computer vision system, lidar system, sonar system, or other sensory systems may perceive an object that was represented in the environment model. After the autonomous vehicle itself perceives an object, the autonomous vehicle can determine whether the perceived object is an object represented in the environment model. For example, an object represented in an environment model may have an associated location and direction of movement. Based on the location and direction of an object perceived by the autonomous vehicle, the autonomous vehicle can determine whether the perceived object is the object represented in the environment model. As noted, the environment model is based on a control stream received from a control stream server. If the autonomous vehicle perceives the object, the flow continues at block 1312. Otherwise, the flow continues at block 1316.

At block 1312, the autonomous vehicle transmits a confirmation to the control data server indicating that an object represented in the control stream was perceived by the autonomous vehicle. As a result, the autonomous vehicle provides a feedback loop which verifies data in the control stream. The flow continues at block 1314.

At block 1314, the autonomous vehicle determines a path avoiding the obstacle. In some embodiments, the autonomous vehicle may rely (in whole or part) on information represented in the environment model to determine a path avoiding the obstacle. In some embodiments, the autonomous vehicle may rely (in whole or part) on information gleaned from local onboard sensors to determine a path avoiding the obstacle. In some embodiments, an obstacle may not necessitate a change in path but instead a change to one or more driving characteristics such as speed, acceleration, deceleration, altitude, trim level (marine), ride height (adjustable suspension systems), etc. The flow continues at block 1316.

At block 1316, the autonomous vehicle updates its environment model based on its own sensor information. For example, the autonomous vehicle may update, based on perceptions of its own sensors, object type, speed, latitude, longitude, direction information, or any other information stored in the environment model. The flow continues at block 1318.

At block 1318, the autonomous vehicle's driving and guidance system determines whether it has reached its destination. If not, the flow loops back to 1206. If so, the flow ends.

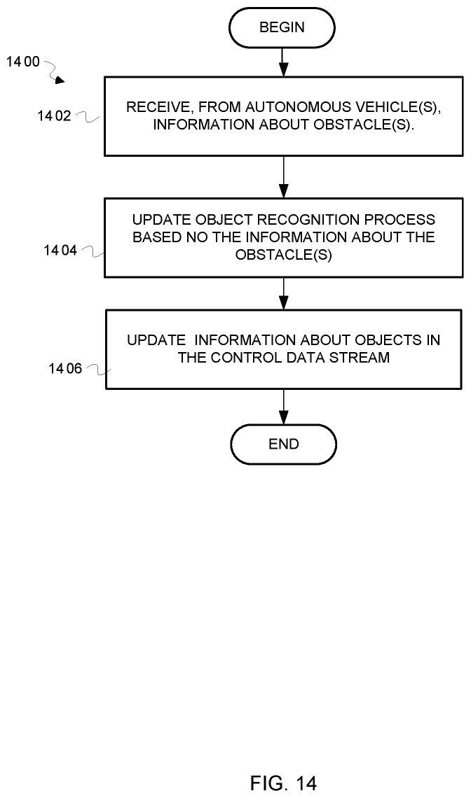

FIG. 14 is a flow diagram illustrating operations for updating control data stream information based on feedback from one or more autonomous vehicles. In FIG. 14, a flow 1400 begins at block 1402. At block 1402, a control data server receives, from one or more autonomous vehicles, information about objects represented in one or more control streams. For example, the information may indicate that an autonomous vehicle itself perceived an object represented in a control data stream. The information can include an autonomous vehicle identifier, information about sensors that perceived the object, location information, speed information, size, mass, temperature, direction information, altitude information, driving characteristics, and any other information that may be used in confirming and updating object data in the control stream. The flow continues at block 1404.

At block 1404, the control data server updates information about objects in the control data stream. For example, if object information received from autonomous vehicles indicates that a particular object was assigned an incorrect object type, the control data server updates the object type. The flow continues at block 1406.

At block 1406, the control data server updates a video object recognition process based on the object information received from the autonomous vehicle. In some instances, the control data server's object recognition process may have incorrectly identified an object. Given enough feedback from autonomous vehicles, the control data server can update its object recognition process to increase its accuracy in identifying objects. For example, feedback (in the form of object information) from autonomous vehicles may indicate that the control data server incorrectly identified a bicycle as an autonomous vehicle. Using the object information, the control data server can modify its object recognition process to avoid future instances in which it incorrectly identifies bicycles. Although this example limited to bicycles, and applies to any type of object or physical phenomenon recognized by the control data server's object recognition.

For embodiments in which the video object recognition is performed external to the control data server, the control data server or autonomous vehicles themselves can transmit the object information directly to whichever components are performing video object recognition (e.g., a video processor).

From 1406, the flow ends.

Although the operations of FIGS. 7-14 have been described with respect to different components (e.g., aerial autonomous vehicle, video processor, control data server, and land-based autonomous vehicles), some embodiments include different components for performing these operations. Embodiments can perform the operations noted herein with any suitable components. Some embodiments perform fewer than all operations shown in the flow diagrams. Some embodiments may perform the operations in an order different than shown herein.

### Autonomous Vehicle Systems

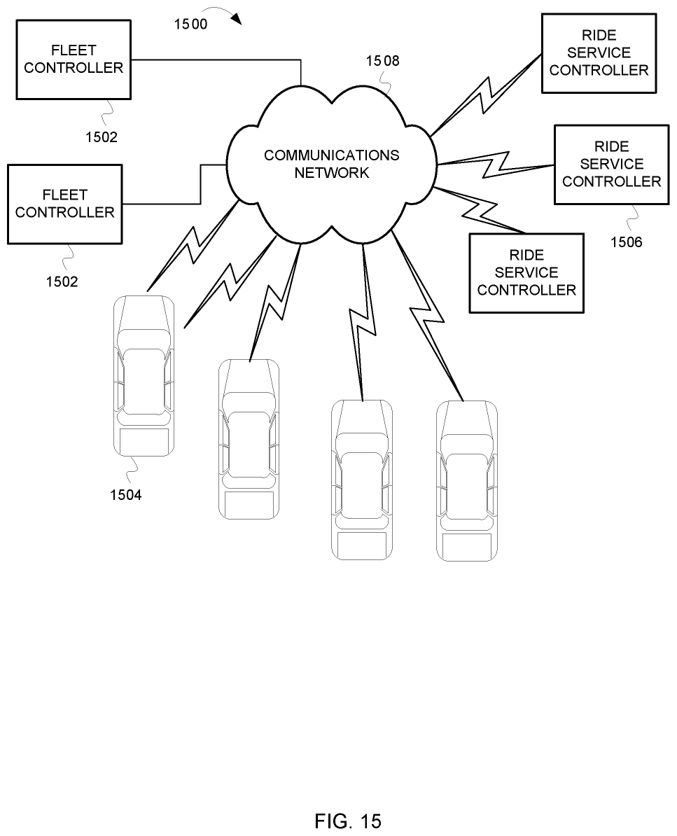

FIG. 15 is a block diagram illustrating components in a system for controlling autonomous vehicles, according to some embodiments of the inventive subject matter. In FIG. 15, a system 1500 includes a communications network 1508 connected to fleet controllers 1502, autonomous vehicles 104, and ride service controllers 1506. The fleet controllers 1502 can reside on any suitable computing device, such as server boxes, rack servers, desktop computers, etc. The autonomous vehicles 1504 can include automobiles or any other suitable vehicle. The ride service controllers 1506 can reside on any suitable computing device, such as a mobile phone, smart phone, handheld computer, laptop, etc. In some embodiments, at least a portion of any ride service controller 1506 can reside on one or more web servers, and can be accessible to users over a network (e.g., the internet).

Additional components and functionality of the fleet controllers 1502, autonomous vehicles 1504, and ride service controllers 1506 will be described in more detail below.

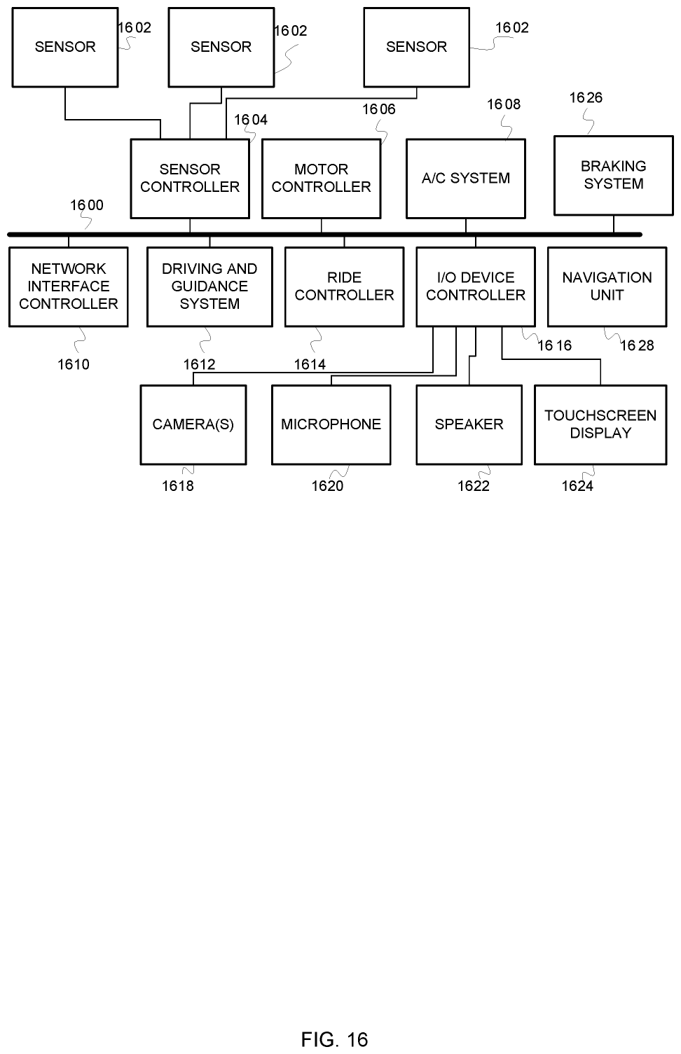

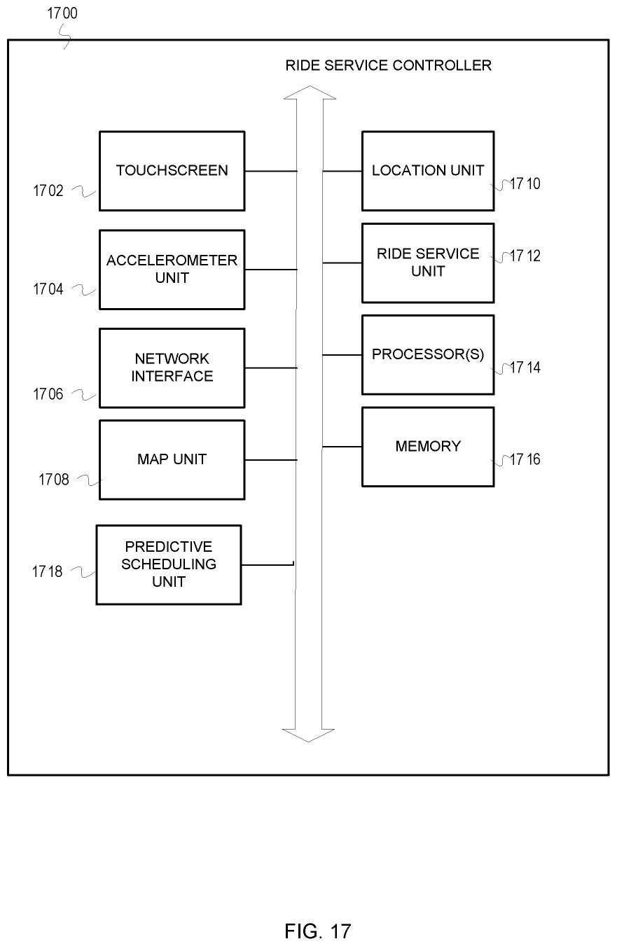

FIG. 16A is a block diagram illustrating control components of an autonomous vehicle, according to some embodiments of the inventive subject matter. One or more of the control components shown in FIG. 16A may be utilized in autonomous vehicles, according to some embodiments. As shown, the components can communicate with each other via the communication pathway 1600.

The driving and guidance system 1612 can include any components necessary for maneuvering, without human input, the autonomous vehicle from start points to destinations, or as otherwise directed by other components of the autonomous vehicle. The driving and guidance system 1612 may control components for steering, braking, and accelerating the autonomous vehicle. In some instances, the driving and guidance system 1612 can interact with other controllers that are configured to control steering systems, braking systems, acceleration systems, etc. Although not shown, a propulsion system including one or more motors (e.g., electrical motors, internal combustion engines, etc.) is included in the driving and guidance system. The driving and guidance system 1612 can also include guidance components, such as radar components, cameras, lidar components, global positioning satellite components, computer vision components, and any other components necessary for autonomously maneuvering the vehicle without human input.

In some embodiments, the autonomous vehicle is embodied as autonomous automobile including wheels powered by a propulsion system and controlled by (i.e., steered by) a steering unit connected to the wheels. Additionally, the autonomous vehicle may include a one or more cabins for transporting passengers, and one or more cargo bins for transporting cargo. This description makes reference to “ride requests” for passengers. However, ride requests may also relate to cargo, and hence any reference to passengers may be construed to mean cargo and any cargo handlers.

The ride controller 1614 is configured to control the autonomous vehicle to perform operations related to providing resources to other vehicles and other operations described herein. In performing these operations, the ride controller 1614 may interact with any of the components shown in FIG. 16. For example, in performing refueling operations, the ride controller 1614 can interact with a navigation unit 1628 to determine navigation information (e.g., maps) for routing the vehicle, and the driving and guidance system 1612 to maneuver the autonomous vehicle to desired destinations (e.g., to refueling rendezvous locations). In further performing these operations, the ride controller 1614 may send and receive information via the network interface controller 1610, send or receive input via the sensor controller 1604, and exchange information with any I/O device via the I/O device controller 1616. In some embodiments, the sensors 1602 do not include components of the driving and guidance system 1612, but may be utilized by any component in the vehicle. The sensors 1602 can include one or more fuel sensors, fluid level sensors, air pressure sensors, ignition timing sensors, temperature sensors (cabin, motor, ambient, etc.), door sensors (sensing whether a door/hood/trunk is open), seat sensors (sensing whether a seat is occupied by passenger), latch sensors, seatbelt sensors, parts sensors (indicating whether a part is present), and airbag sensors. Some of the sensors can be disposed in or about a combustion engine, such as one or more mass air flow sensors, manifold air pressure sensors, oxygen sensors, crankshaft position sensor, camshaft position sensors etc. Some embodiments include sensors particular to electric motors. The sensors can also include tire pressure sensors, throttle position sensors, and wheel speed sensors. The sensors can also include wheel sensors capable of determining wheel rotation for determining movement and orientation of the vehicle. In some embodiments, the ride controller 1614 periodically polls the sensor controller 1604 to monitor the state of the autonomous vehicle. In some embodiments, the ride controller records the sensor readings for future analysis.

The motor controller 1606 is configured to control one or more motors that provide power for ling the vehicle or for generating electricity used by an electric motor that propels the vehicle. The AC system 1608 includes all components necessary to provide air-conditioning and ventilation to passenger compartments of the autonomous vehicle. Network interface controller 1610 is configured to control wireless communications over any suitable networks, such as wide area networks (e.g., mobile phone networks), local area networks (e.g., Wi-Fi), and personal area networks (e.g., Bluetooth). The I/O device controller 1616 controls input and output between camera(s) 1618, microphone(s) 1620, speaker(s) 1622, and touchscreen display(s) 1624. The I/O controller 1616 can enable any of the components to utilize the I/O devices 1618-1624.

FIG. 16B is a block diagram illustrating operations for driving and guiding an autonomous vehicle, according to some embodiments. In some embodiments, the operations of FIG. 16B are performed by an autonomous vehicle's driving and guidance system (e.g., see FIG. 16A's block 1612). Embodiments may use any known or later developed techniques for maneuvering an autonomous vehicle over roads to a destination. In FIG. 2B, the flow diagram 1650 begins at block 1652.

At block 1652, an autonomous vehicle's driving and guidance system determines a destination and current location. In some embodiments, the autonomous vehicle's driving and guidance system receives an indication of the destination from other components of the autonomous vehicle. For example, the vehicle's ride controller may provide the destination to the driving and guidance system. In some embodiments, the driving and guidance system utilizes global positioning satellite data (e.g., provided by navigation unit), map information, inertial navigation information, odometery, etc. to determine a current location and orientation. Additionally, the driving and guidance system may use sensors, such as cameras and lidar to better determine its current location. Any known techniques for computer vision and lidar processing can be used. The flow continues at block 1653.

At block 1653, the autonomous vehicle's driving and guidance system determines a path to the destination. Embodiments can utilize any suitable path determining algorithm, such as shortest path, fastest path, etc. In some embodiments, the path is provided by a user, external system, or other component. Embodiments can utilize any known or otherwise suitable techniques for path planning to determine a path to the destination. The flow continues at block 1654.

At block 1654, the autonomous vehicle's driving and guidance system propels the vehicle along the path. As the vehicle proceeds along the path, the driving and guidance system is continuously processing sensor data to recognize objects and obstacles (i.e., impediments to safety and progress). The flow continues at block 1656.

At block 1656, the autonomous vehicle's driving and guidance system determines whether one or more obstacles are encountered. The driving and guidance system can use various sensors to perceive the ambient environment including cameras, lidar, radar, etc. The driving and guidance system can also use any suitable techniques for object detection and recognition (e.g., computer vision object detection) to recognize obstacles. Obstacles can include moving obstacles, stationary obstacles, changes in terrain, traffic rules, etc. Obstacle detection can involve known techniques for determining the vehicle's own motion relative to other objects. Motion determination can include any know techniques for processing steering angular rates, data from inertial sensors, data from speed sensors, data from cameras, lidar, etc. Known video processing techniques can be used when processing camera data and can include known techniques of video-based object recognition and motion estimation. Known uses of Velodyne lidar are suited for detecting and tracking objects in traffic, as such techniques can classify data into passenger cars, trucks, bikes, and pedestrians by having based on motion behavior. In addition to tracking objects, some embodiments perform road shape estimation utilizing any suitable techniques such as clothoidal systems or B-spline models for 3D lane representation. By projecting a 3D lane estimate into images, measurements of directed edges of lane markings can be performed. Lidar can be used to determine curbs. Techniques for road shape estimation can work along with techniques for modeling whether an obstacle has been encountered. The flow loops back to block 1653. Upon loop back to block 1653, the driving and guidance system determines a path around the obstacle toward the destination. From block 1653, the flow continues at block 1654. Referring back to block 2156, if an obstacle is not encountered, the flow continues at block 1658.

At block 1658, the autonomous vehicle determines whether the destination has been reached. The autonomous vehicle's driving and guidance system can make this determination based on GPS data, camera and lidar data (e.g., object recognition such as a landmark), user input, or other suitable information. If the destination has not been reached, the flow continues at block 254. If the destination has been reached the flow ends.

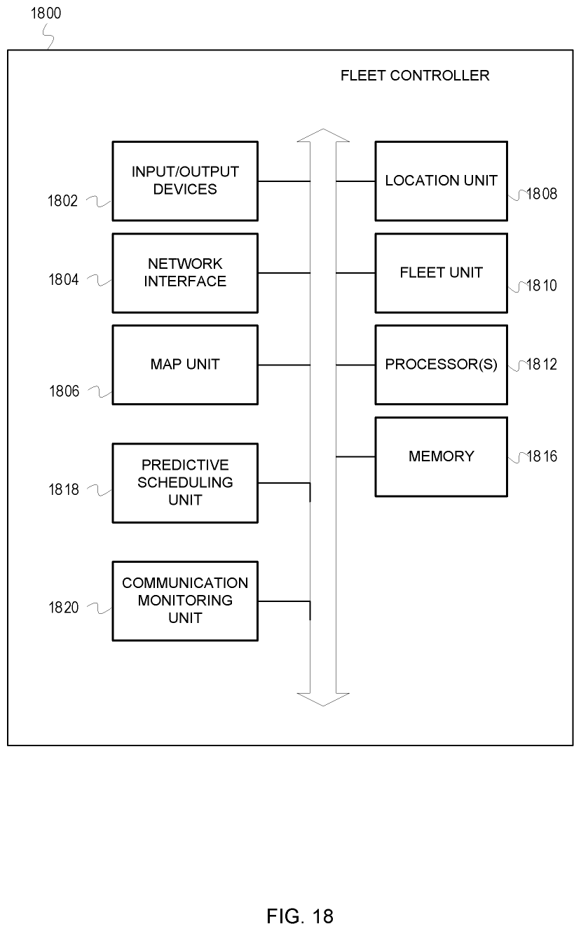

FIG. 17 is a block diagram of a ride service controller, according to some embodiments of the inventive subject matter. In FIG. 17, a ride service controller 300 includes a touchscreen 302, accelerometer unit 304, network interface 1706, map unit 1708, location unit 1710, ride service controller 1712, processor(s) 1714, memory 1716, and predictive schedule unit 1718. In some embodiments, the location unit 1710, ride services unit 312, map unit 1708, and other suitable components (not shown), can wholly or partially reside in the memory 1716. In some embodiments, the memory 1716 includes semiconductor random access memory, semiconductor persistent memory (e.g., flash memory), magnetic media memory (e.g., hard disk drive), optical memory (e.g., DVD), or any other suitable media for storing machine-executable instructions and information.

The map unit 1708 can provide map information (street address information, GPS information, etc.) to any component of the ride service controller 1700 or other components external to the ride service controller 1700. The location unit 1710 can receive and process global positioning satellite (GPS) signals and provide GPS information to components internal or external to the ride service controller 1700. The accelerometer unit 1704 can detect motion, acceleration, and other movement information. The ride services unit 1712 can utilize information from any component internal or external to the ride service controller 1700. In some embodiments, the ride services unit 1712 performs operations for coordinating customer rides in autonomous vehicles, as described herein. The predicted scheduling unit 1718 can predictively request ride service for a user.

In some embodiments, ride service controllers can be included in smart phones and other mobile devices. In some embodiments, ride service controllers are portable devices suitable for carrying by ride customers. In some embodiments, ride service controllers are distributed as software applications for installation on smart phones, which provide hardware functionality for use by the software applications. Therefore, ride service controllers can be embodied as computer-executable instructions residing on tangible machine-readable media.

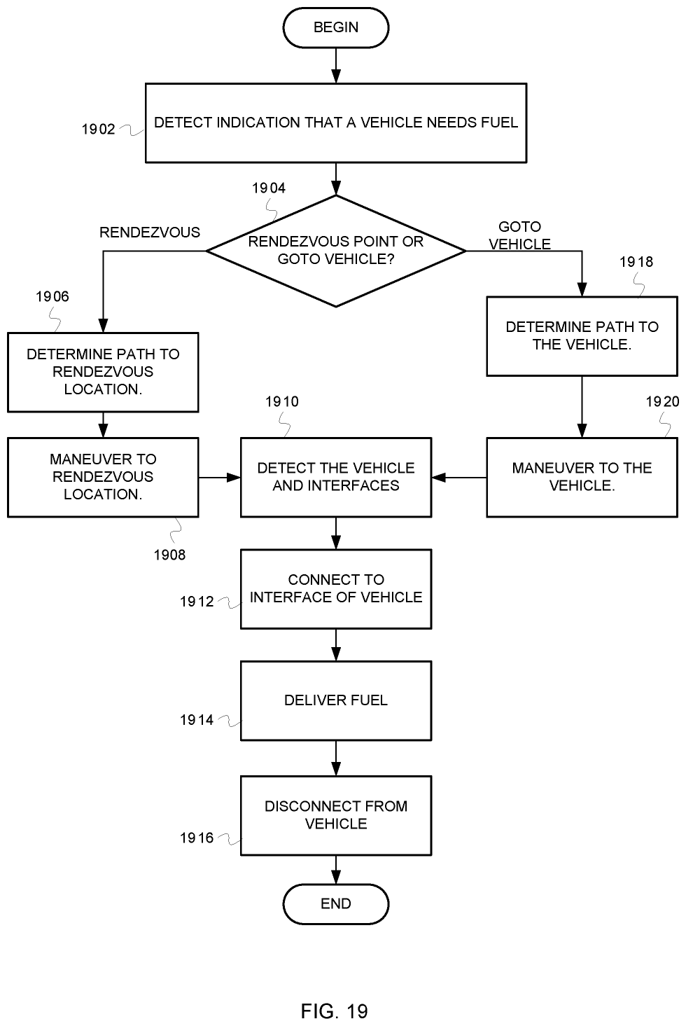

FIG. 18 is a block diagram of a fleet controller, according to some embodiments of the inventive subject matter. In FIG. 18, the fleet controller 1800 includes input output devices 1802, network interface 1804, map unit 1806, location unit 1808, fleet unit 1810, processor 1812, memory 1816, and predictive schedule unit 1818.

In some embodiments, the fleet controller 1800 communicates with a plurality of ride service controllers. In some embodiments, the location unit 1808 receives location information associated with ride service controllers, and determines locations of those ride service controllers. The map unit 1806 can utilize information from the location unit to determine map locations for ride service controllers. The fleet unit 1810 can perform operations for coordinating rides with autonomous vehicles. The components in the fleet controller 1800 can share information between themselves and with components external to the fleet controller 1800.

In some embodiments, the location unit 1808, fleet unit 1810, map unit 1806, and other suitable components (not shown), can wholly or partially reside in the memory 1816. In some embodiments, the memory 1816 includes semiconductor random access memory, semiconductor persistent memory (e.g., flash memory), magnetic media memory (e.g., hard disk drive), optical memory (e.g., DVD), or any other suitable media for storing information. The processor(s) 1812 can execute instructions contained in the memory 1816. The predictive schedule unit 1818 can predictively request ride service for particular user accounts.

This description describes capabilities of, and operations performed by, components discussed vis-à-vis the Figures discussed above. However, according to some embodiments, the operations and capabilities can be included in different components. In some embodiments, autonomous vehicles can be implemented as “thick devices”, where they are capable of accepting ride requests published by a fleet controller, and they can communicate directly with ride service controllers and other devices. In some implementations, autonomous vehicles may communicate certain messages to fleet controllers, which forward those messages to autonomous vehicles or other components. Therefore, some embodiments support direct communication between autonomous vehicles and ride service controllers, and some embodiments support indirect communication (e.g., message forwarding). In some embodiments, autonomous vehicles are capable of determining ride routes, and may receive user input for selecting between ride routes determined by the autonomous vehicle. In some embodiments, all operations for maneuvering an autonomous vehicle are performed by a driving and guidance system. The driving and guidance system is capable of receiving information and instructions from a ride controller, where the ride controller performs operations for determining rides for the autonomous vehicle. Based on the rides, the ride controller provides instructions and information for enabling the driving and guidance system to maneuver to locations associated with ride requests, and other requests.

In some embodiments, autonomous vehicles may be implemented as “thin devices”. Therefore, some embodiments do not receive a stream of published ride requests from which they choose rides, but instead are assigned rides by a fleet controller or other device. That is, a fleet controller may select the ride and assign it directly to a particular autonomous vehicle. In some implementations, autonomous vehicles do not select routes for rides that have been assigned. Instead, the vehicles may receive routes from fleet controllers or other devices. In some implementations, autonomous vehicles may not communicate with ride requesters, but instead receive information from fleet controllers (where the fleet controllers communicate with ride requesters). Furthermore, in some implementations, the autonomous vehicles may not make decisions about rendezvous points, service request, or other operations described herein. Instead, the decisions may be made by fleet controllers or other components. After making such decisions, the fleet controllers provide to vehicles information carrying out assignments.

In some embodiments, autonomous vehicles may be implemented as hybrids between thick and thin devices. Therefore, some capabilities may be implemented in the autonomous vehicles, while other capabilities may be implemented in the fleet controllers or other devices.

### Providing Fuel/Resources to AV

As autonomous vehicles operate over time, they may need to replenish resources such as fuel, fluids, etc. Additionally, passengers may want resources which are currently unavailable in autonomous vehicles. As a result, some embodiments of the inventive subject matter describe techniques for replenishing resources for autonomous vehicles.

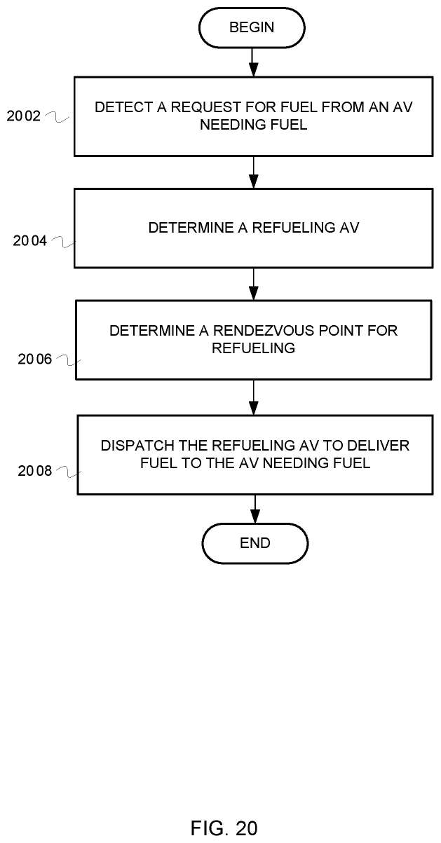

FIG. 19 is a flow diagram illustrating operations for replenishing resources of an autonomous vehicle, according some embodiments of the inventive subject matter. In some embodiments, operations shown in FIG. 5 are performed by a resource vehicle—an autonomous vehicle capable of providing resources (e.g., fuel) to other autonomous vehicles. The flow 1900 begins at block 1902.

At block 1902, a resource delivery vehicle's ride controller receives an indication that an autonomous vehicle needs resources (e.g., fuel). The ride controller may receive the indication via a network interface, such as an interface to a 5G or other suitable telecommunications network. In some embodiments, the indication includes all necessary information for delivering the requested resource to the recipient vehicle. For example, the indication may identify the resource needed (e.g., fuel type), rendezvous location at which the resource will be provided, rendezvous time, and any other information necessary for delivering the resource. In some embodiments, the resource delivery vehicle will deliver the resource in-flight (i.e., while both vehicles are moving). In other embodiments, the resource delivery vehicle may receive additional communications including information necessary for providing needed resources. For in-flight deliveries, the resource delivery vehicle may dynamically determine a path to the recipient vehicle. The flow 1900 continues at block 1904.

At block 1904, the resource delivery vehicle's ride controller determines whether the delivery will be at a rendezvous point or in in-flight delivery. For a rendezvous point, the flow continues at block 1906. For in in-flight delivery, the flow continues at block 1912.

At block 1906, the resource delivery vehicle's ride controller determines a path to the rendezvous location. At block 1908, the resource delivery vehicle maneuvers to the rendezvous location. From block 1908, the flow continues at block 1910.

At block 1918, the resource delivery vehicle's ride controller determines a path to the recipient vehicle. The ride controller may dynamically update path information based on the recipient vehicle's location. At block 1920, the resource delivery vehicle maneuvers to the recipient vehicle according to the path information. The flow continues at block 1910.

At block 1910, the resource delivery vehicle detects the recipient vehicle and the recipient vehicle's interfaces. The interfaces can include mechanical interfaces, electrical interfaces, and wireless interfaces. Mechanical interfaces can include conduits through which resources (e.g., fuel, food, dry goods, etc.) can be passed from the delivery vehicle to the recipient vehicle. In some implementations, the recipient vehicle may pass physical items through the conduit to the delivery vehicle (e.g., fuel canisters, garbage, packaging or other material associated with consumable resources, etc.). The electrical interfaces may be wires or other conduits that facilitate exchange electrical signals and power. The wireless interfaces can be any suitable wireless network interfaces that facilitate wireless communications. In some embodiments, the wireless interfaces can facilitate power delivery to the recipient vehicle. The flow continues at block 1912.

At block 1912, the resource delivery vehicle connects to the recipient vehicle via one or more interfaces. For example, the resource delivery vehicle may include a boom-mounted conduit configured to connect to the recipient vehicle's fuel interface. The boom may be mounted on a top surface of the delivery vehicle and rotate 360° about the top surface. The boom may be capable of raising and lowering to various heights to accommodate a range of recipient vehicles. The flow continues at block 1914.

At block 1914, the resource delivery vehicle delivers one or more resources to the recipient vehicle. For example, the resource delivery vehicle may pump fuel through the conduit to the recipient vehicle. As another example, the resource delivery vehicle may provide packaged food via the conduit to the recipient vehicle. The flow continues at block 1916.

At block 1916, the resource delivery vehicle disconnects from one or more interfaces of the recipient vehicle. For example, the delivery vehicle disconnects the conduit and electrical wiring from the recipient vehicle. From block 1916, the flow ends.

While FIG. 19 describes operations by which a resource vehicle delivers resources, the discussion continues with a description of operations for processing resource requests and dispatching resource vehicles. In some embodiments, resource vehicles may be dispatched by one or more fleet controllers.

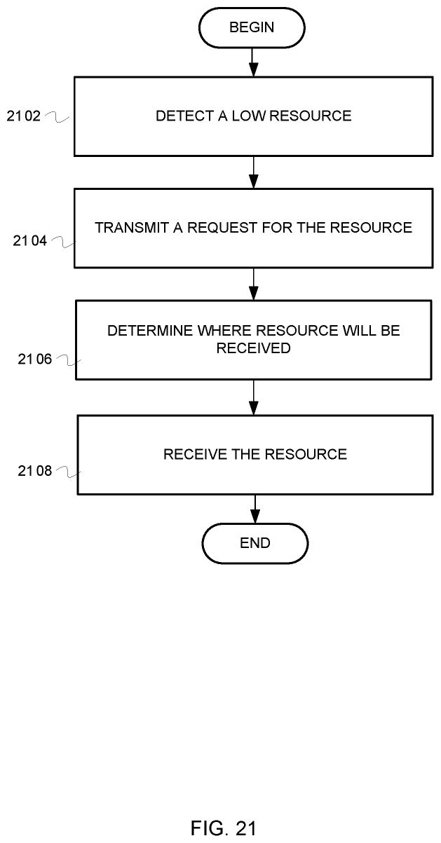

FIG. 20 is a flow diagram illustrating operations for processing resource requests, according to some embodiments. In FIG. 20, a flow 2000 begins at block 2002 where a fleet controller detects a resource request from an autonomous vehicle. In some implementations, the request is received from an autonomous vehicle or ride service controller over a 5G or other suitable telecommunications network. The request may specify the resource needed, quantity of resource needed, a rendezvous location, and any other information that may be helpful in facilitating acquisition of resources. Although some autonomous vehicles themselves may request resources, some embodiments operate differently. The fleet controller may monitor resources on-board an autonomous vehicle. As the fleet controller detects a need for resources, the fleet controller may automatically dispatch a resource vehicle to replenish needed resources without any request from the autonomous vehicle. The flow continues at block 2004.

At block 2004, the fleet controller determines a resource vehicle to provide the requested resource. For example, the fleet controller may select resource vehicles based on their proximity to the requesting vehicle, type/quantity of resources on board resource vehicles, etc. the flow continues at block 2006.

At block 2006, the fleet controller determines rendezvous parameters by which the resource vehicle will provide the requested resource to the requesting vehicle. In some embodiments, the rendezvous parameters call for the vehicles to stop before resources are delivered. In other instances, the rendezvous parameters call for resource delivery wall both vehicles are moving (e.g., in-flight delivery). The flow continues at block 2008.

At block 2008, the fleet controller dispatches the resource vehicle to deliver the requested resource based on the rendezvous parameters. In some embodiments, the fleet controller transmits a message to the resource vehicle. The message may include the rendezvous parameters, the resource needed, the quantity of the resource needed, etc. From block 2008, the flow ends.

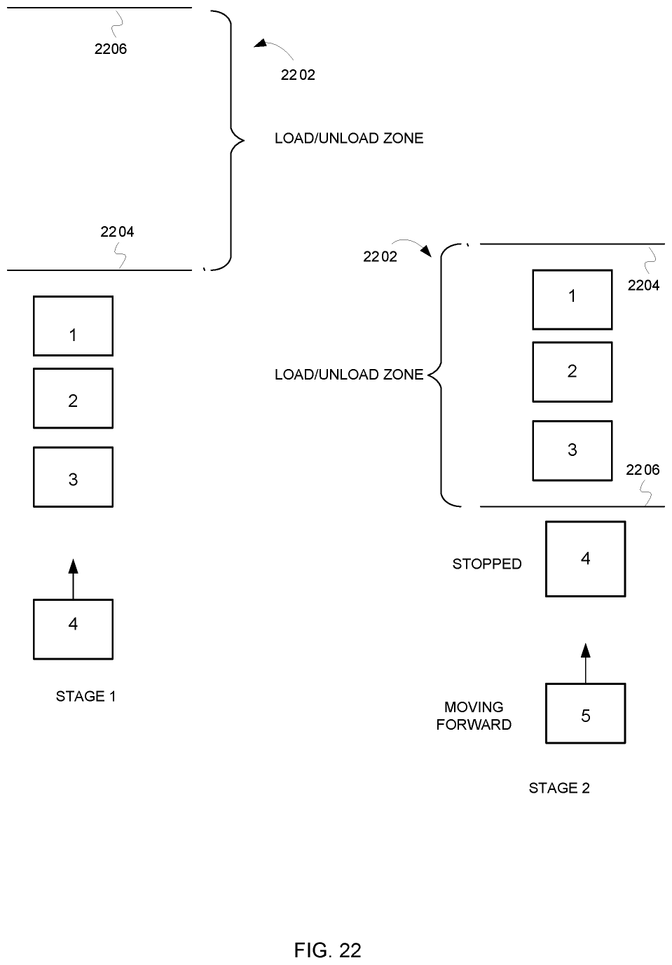

FIG. 21 is a flow diagram illustrating operations for an autonomous vehicle requesting and receiving resources, according to some embodiments of the inventive subject matter. In FIG. 21, a flow 2100 begins at block 2102 where an autonomous vehicle detects in low resource. For example, an autonomous vehicle may detect low fuel, engine oil, cabin supplies (e.g., food, water, etc.), etc. The flow 2100 continues at block 2104.

At block 2104, the autonomous vehicle transmits a request for the resource. For example, the autonomous vehicle may transmit a resource request to a fleet controller. Alternatively, the autonomous vehicle may transmit the resource request directly to a resource delivery vehicle. The resource delivery vehicle may be an autonomous vehicle. The flow continues at block 2106.

At block 2106, the autonomous vehicle determines where it will receive the resource. In some instances, the autonomous vehicle receives the resource at a rendezvous point. At the rendezvous point, the autonomous vehicle may receive the resource from an autonomous resource delivery vehicle. In other instances, the autonomous vehicle receives the resource in-flight. That is, the autonomous vehicle receives the resource in transit without stopping. The autonomous vehicle may receive in-flight resources in route to a destination (e.g., a passenger drop-off destination). Alternatively, the autonomous vehicle may determine a resource delivery vehicle's route and maneuver to the resource delivery vehicle. The flow continues at block 2108.

At block 2108, the autonomous vehicle receives the resource. In some instances, the times vehicle autonomously receives the resource directly from the resource delivery vehicle. In other instances, the autonomous vehicle may receive the resource from human (e.g., at a rendezvous point such as a gas station). From block 2108, the flow ends.

Embodiments of the inventive subject matter may detect an autonomous vehicle's need for resources in various ways. In some implementations, autonomous vehicles include sensors that report (periodically, continuously, on-demand, when a threshold is reached, etc.) resource information (e.g., amount of particular on-board resources) to one or more fleet controllers. Fleet controllers receive the resource information and determine when to replenish particular resources. In other embodiments, the autonomous vehicles themselves recognize a need for one or more resources and transmit requests for those resources. In yet other embodiments, ride service controllers may receive user input requesting resources. For example, a passenger may request food via a ride service controller. The ride service controller may transmit the request to a fleet controller which may process the request as per FIG. 6.

Although some embodiments utilize a fleet controller to facilitate resource delivery, other embodiments do not. A requesting vehicle may request resources directly from resource delivery vehicles. For example, the requesting vehicle may publish a request for resources. Resource delivery vehicles may respond to requests based on their availability, proximity, etc. If a plurality of resource delivery vehicles respond to the request, there may be a protocol for selecting between resource delivery vehicles. Such a protocol may select the resource delivery vehicle based on: earliest responder to the request, the responder with best reputation for delivery, the responder able to deliver most quickly, or any suitable parameter or combination of parameters.

### Automated Passenger Unloading/Loading

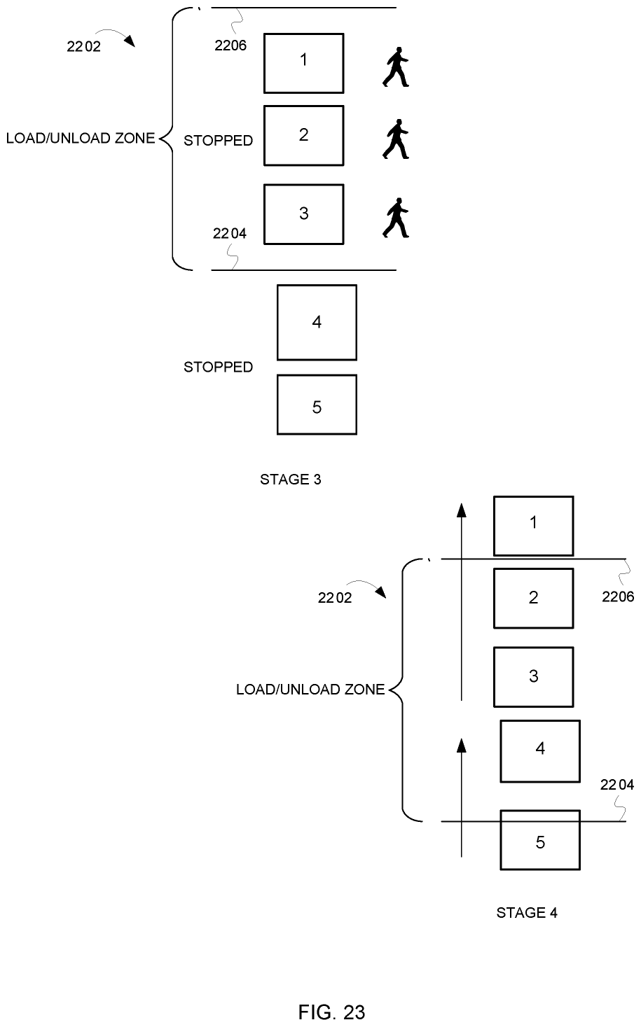

FIGS. 22-26 describe techniques for unloading passengers in a designated unloading/loading zone. FIGS. 22-24 shows stages for unloading passengers in an unloading zone. FIG. 20 shows operations for controlling an autonomous vehicle moving into and out of an unloading zone.

FIG. 22 is a conceptual diagram presenting stages 1 and 2 of five consecutive stages showing autonomous vehicles unloading passengers in an unloading zone. In FIG. 22, an unloading zone 2202 is marked by two lines 2204 and 2206. Line 2204 indicates a beginning of the loading zone and line 2206 indicates an end of the loading zone. In FIG. 22, four autonomous vehicles are approaching the loading zone 2202. Each of the vehicles are carrying passengers (not shown in FIG. 22). During stage 1, the loading zone 2202 is empty (i.e., there are no vehicles or pedestrians in the loading zone). Vehicle 1, vehicle 2, vehicle 3 and vehicle 4 are approaching the loading zone. Vehicle 1 is closest to the line 2204 marking the beginning of the loading zone 2206. Vehicle 2 and vehicle 3 are closely following vehicle 1. Vehicle 4 is some distance behind vehicle 3.

During stage 2, vehicle 1, vehicle 2, and vehicle 3 drive into the unloading zone 2202. According some embodiments, the first vehicle entering an empty unloading zone proceeds to the end of the unloading zone (line 2206). The following vehicles proceed in the loading zone until the lead vehicle (e.g., vehicle 1) stops at the end line 2206. As a result, all vehicles synchronously move into the unloading zone and stop in succession. Additionally, the vehicles move as far into the unloading zone as possible without colliding with other vehicles and without exiting the loading zone.

As shown, during stage 2, vehicles 1-3 are in the loading zone, while vehicle 4 stops before the line 2206. Vehicle 5 is proceeding toward the unloading zone 2204 and will stop behind vehicle 4. When the loading zone is full, vehicles move up to the line 2204 but do not enter the unloading zone 2202.

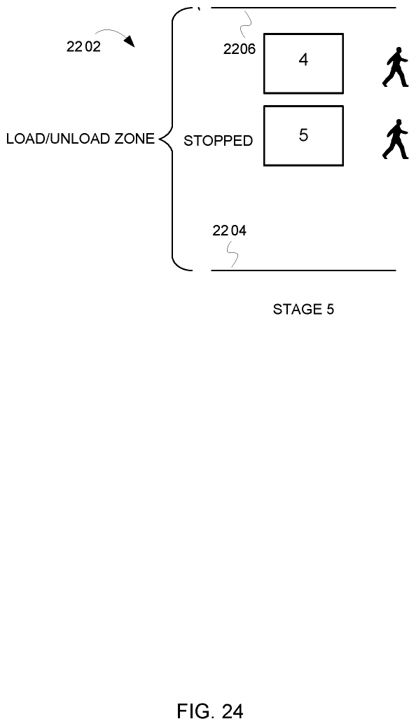

Stages 3 and 4 are shown in FIG. 23

FIG. 23 is a conceptual diagram illustrating stages 3 and 4 of the five consecutive stages of autonomous vehicles unloading passengers in an unloading zone. In stage 2 (FIG. 22), the autonomous vehicles 1-3 entered and stopped in the loading zone. During stage 3, autonomous vehicles 1-3 unload passengers. In some embodiments, the vehicles do not enable passengers to exit until all cars in the loading zone have stopped. The vehicles may determine whether cars are stopped based on their sensors (e.g., lidar, radar, sonar, camera and image processing, etc.), communications from vehicles about their movements and stops, etc. After all cars are stopped, the vehicles 1-3 allow passengers to unload. In some embodiments, the autonomous vehicles may keep doors locked until it is safe to unload. In some embodiments, the vehicles may present a notification (audio message, video message, etc.) to passengers that it is safe to unload. In some embodiments, the forward-most vehicle can exit the unloading zone 802 after all passengers have unloaded. While the passengers are unloading, vehicles 4-5 are waiting outside the loading zone. Other vehicles may queue-up behind vehicles 4-5 while waiting to enter the loading zone. The loading zone 2202 accommodates three vehicles, but embodiments can operate with any size loading zone.

Stage 4 shows vehicles 1-3 exiting the loading zone while vehicles 4-5 are entering the loading zone. During stage 5 (see FIG. 24), vehicles 4 proceeds to the line 2206 (i.e. the end of the unloading zone) and vehicle 5 follows and stops behind vehicle 4. After all vehicles in the unloading zone have stopped, the vehicles unlock their doors and allow their passengers to unload.

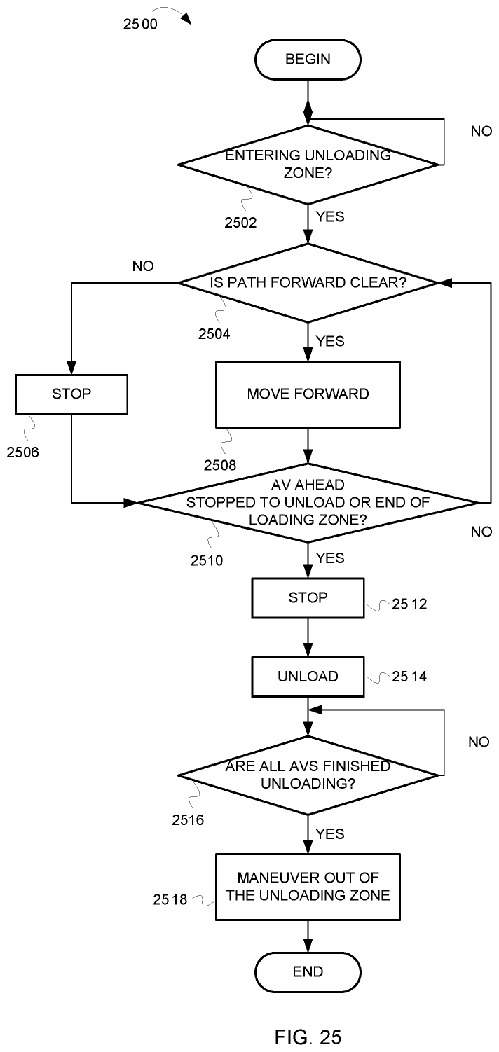

FIG. 25 is a flow diagram illustrating operations controlling an autonomous vehicle in an unloading zone, according to some embodiments of the inventive subject matter. In FIG. 25, a flow 2500 begins at block 2502. At block 2502, an autonomous vehicle determines whether it is entering an unloading zone. In some embodiments, the autonomous vehicle's driving and guidance system determines whether the vehicle has entered a unloading zone. For example, the driving and guidance system may include a camera and computer vision capabilities that analyze the vehicle's surroundings. The driving and guidance system may perceive road signs, road surface markings, etc. that indicate the vehicle is entering an unloading zone. If the vehicle is entering a loading zone, the flow continues at block 2504. Otherwise, the flow loops back to block 2502.

At block 2504, the autonomous vehicle determines whether the path forward is clear. In some embodiments, the vehicle's driving and guidance system determines whether there are obstacles in the vehicle's path. For example, the driving and guidance system may utilize lidar, computer vision, sonar, and other techniques for detecting obstacles. Obstacles may include pedestrians, stopped vehicles, animals, objects, etc. If the path forward is not clear, the flow continues at block 2506. Otherwise, the flow continues at block 2508.

At block 2506, the autonomous vehicle stops. From block 2506, the flow continues at block 2510.

At block 2508, the autonomous vehicle moves forward. From block 2508, the flow continues at block 2510.

At block 2510, the autonomous vehicle determines whether it has encountered an autonomous vehicle stopped ahead and whether it is at the end of the unloading zone. If the vehicle is stopped ahead or the autonomous vehicle is at the end of the unloading zone, the flow continues at block 2512. Otherwise, the flow loops back to block 2504.

At block 2512, the autonomous vehicle stops. The flow continues at block 2514.

At block 2514, the autonomous vehicle performs unload operations. Unload operations can include unlocking doors and otherwise enabling passengers to exit the vehicle. Additionally, the autonomous vehicle may notify other vehicles that it is unloading, such as by presenting indicators, communications, etc. that indicate the autonomous vehicle is stopped an unloading in the unloading zone. The flow continues at block 2516.

At block 2516, the autonomous vehicle determines whether unloading in the unloading zone is complete for autonomous vehicles. In some embodiments, the autonomous vehicle utilizes computer vision to determine whether passengers are still unloading from autonomous vehicles in an unloading zone. In some embodiments, autonomous vehicles may indicate when unloading is complete. After all vehicles in the unloading zone indicate unloading is complete (e.g., the autonomous vehicle receives a message from all vehicles in the unloading zone), the autonomous vehicle concludes that the unloading is complete. If unloading is complete, the flow continues at block 2518. Otherwise, the flow loops back to 2516.

At block 2518, the autonomous vehicle maneuvers out of the unloading zone. From block 2518, the flow ends.

Similar to the unloading operations noted herein, some embodiments perform automated loading. Embodiments can perform automated loading with operations similar to those shown in FIG. 25. When loading, all of FIG. 25's operations related to unloading will be changed to loading operations. For loading, passengers enter the autonomous vehicle, so the vehicle may unlock doors, adjust seats, etc. After passengers are loaded, the vehicle may lock doors and check sensors to ensure all safety equipment is engaged (e.g., seat belts).

### Autonomous-Vehicle-Based Video Capture

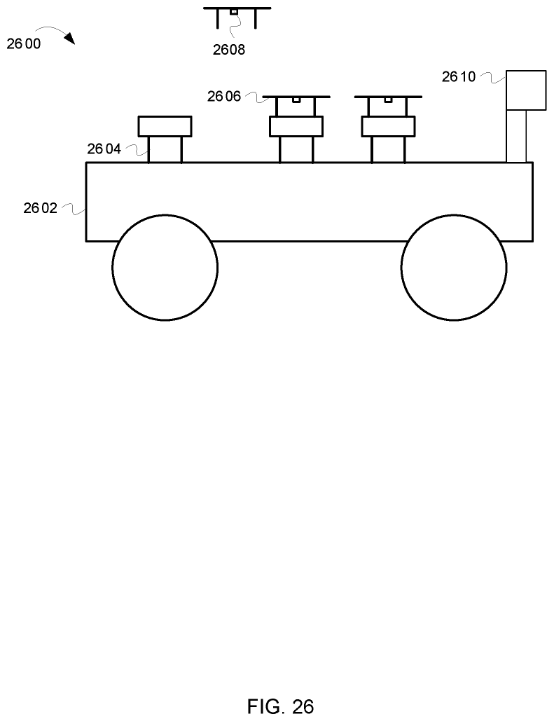

Some embodiments of the inventive subject matter control autonomous vehicles in a process for capturing video. More specifically, some embodiments can monitor a communication channel and deploy autonomous vehicles to a geographic locale for the purpose of capturing video at the locale. FIG. 26 is a conceptual diagram illustrating an autonomous vehicle system configured for video capture. An autonomous vehicle system 2600 includes a land-based autonomous vehicle 2602 includes platforms 2604 on which the land-based vehicle transports the aerial autonomous vehicles to a locale. The land-based autonomous vehicle 2604 can include any suitable number of platforms to accommodate any suitable number of aerial autonomous vehicles. The platforms 2604 can be configured to charge batteries in the aerial autonomous vehicles 2606 when the vehicles are on the platforms. In some embodiments, the platforms 2604 include contact charging pads, inductive charging pads, or any other suitable means for charging batteries in the aerial autonomous vehicles 2606. Although not shown, some embodiments include coil systems that facilitate the charging process. Although FIG. 26 shows its basic form, the land-based autonomous vehicle 2602 can include all components necessary for maneuvering to a destination.

The land-based autonomous vehicle 2602 also includes a video capture device 2610. The video capture devices 2608 can include digital cameras, film-based cameras, infrared cameras, thermal imaging components, and any other suitable component for capturing video content. In some embodiments, the video capture devices 2608 include components that can capture and present 360-degree video content. In some implementations, multiple cameras capture overlapping images, and those images are stitched together to form a 360-degree image. The images can be part of one or more streams of motion picture video content. The vehicle 2602 can include multiple video capture devices, although only one is shown in FIG. 26. The video capture devices can be mounted on a boom that telescopes vertically and in any direction.

As shown, the aerial autonomous vehicles 2606 include video capture devices 2608. The video capture devices 2608 can include digital cameras, film-based cameras, infrared cameras, thermal imaging components, and any other suitable component for capturing imagery. In some embodiments, the video capture devices 2608 include components that can capture and present 360-degree images. In some instances, multiple cameras (on a single aerial autonomous vehicle) capture overlapping images, and those images are stitched together to form a 360° image. All the video capture devices described herein can also capture audio using microphones, lasers, etc. The video capture devices can capture any suitable form of video such as motion picture video, single image video, etc. The video capture devices can store the video content in any suitable format.

The aerial autonomous vehicles may include any suitable components for flying such as wings, rotating blades, motors, etc. The aerial vehicles may include any of the components shown in FIG. 2 suitable for facilitating autonomous flight. Instead of a driving and guidance system shown in FIG. 2, the aerial autonomous vehicles include a flight control and guidance system that utilizes sensors (e.g., camera, radar, altimeter, pitch and yaw indicator, etc.) to control and maneuver the vehicle during flight. Additionally, the aerial autonomous vehicle includes an image processor that can identify objects via computer vision. The aerial autonomous vehicles and the land-based autonomous vehicles include wireless and wired network connectivity over which they can transmit video content and other communications that facilitate their operation.

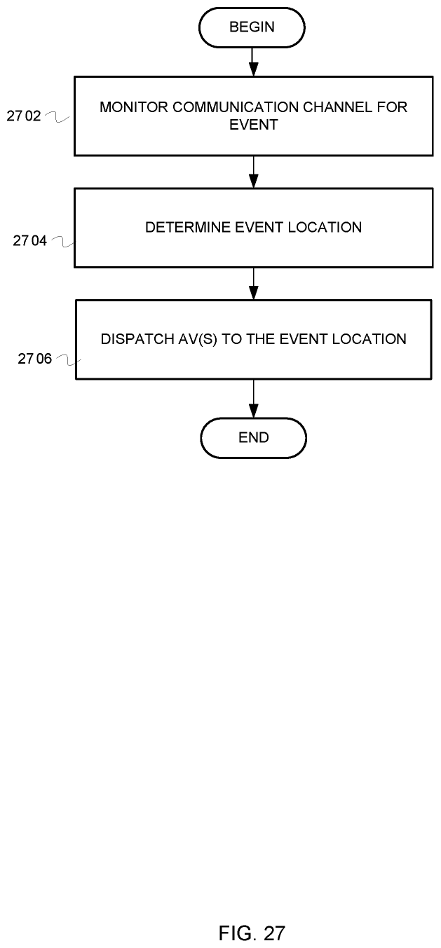

As noted, embodiments can monitor a communication channel and deploy aerial autonomous vehicles to capture video. FIG. 27 is a flow diagram illustrating operations for monitoring the communication channel and dispatching an autonomous vehicle system, according to some embodiments. In some embodiments, a fleet controller performs the operations shown in FIG. 27. In FIG. 27, a flow 2700 begins at block 2702.

At block 2702, a fleet controller's communication monitoring unit 1820 monitors a communication channel for an indication that an event has occurred. The communication channel may be a radio channel (e.g., an unencrypted public radio channel, a citizen's band radio channel, an FM radio channel, AM radio channel, etc.), a text-based messaging channel, air-based television channel, cable television channel, a telephone channel, or any other suitable communication channel. For example, the communication channel may be a public emergency radio channel. The channel content may include audio content indicating a conversation in which a member of the public reports an emergency situation at a location. Events can include emergency situations such as fires, criminal activities, car crashes, etc. Events may also include unexpected crowds, street situations, activities that may be of interest to authorities and the public, etc.

In some embodiments, the channel monitoring unit is capable of monitoring the channel and performing natural language processing on data transmitted over the channel. For example, the channel monitoring unit can translate audio communications into text or other data forms that are processable by the channel monitoring unit. Using natural language processing, the fleet controller's channel monitoring unit can determine whether communications over the channel included certain keywords that indicate particular events. Although some embodiments use natural language processing to detect event indicators, other embodiments can detect event indicators without natural image processing. For example, event indicators may explicitly indicate particular events, and data about those events (e.g., event location, event time, etc.). The flow continues at block 2704.

At block 2704, the fleet controller's channel monitoring unit determines a location of the event. In some embodiments, the channel monitoring unit determines the event location based on the natural language processing applied to natural language content over the communication channel. Alternatively, the content may include an explicit indication of the event and the event location. The flow continues at block 2706.

At block 2706, the fleet controller dispatches the autonomous vehicle system (see FIG. 12) to the location. From block 2706, the flow ends.

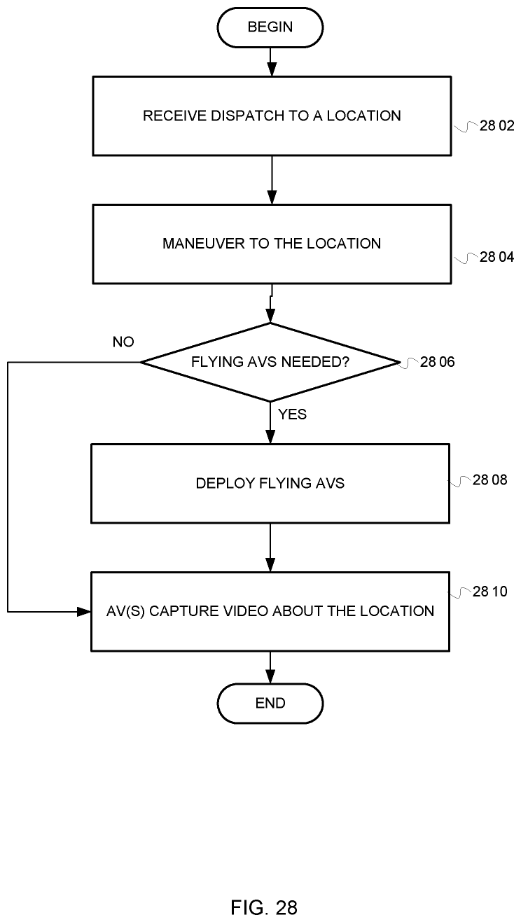

FIG. 28 is a flow diagram illustrating operations by which the autonomous vehicle system deploys to a location to capture video, according to some embodiments of the inventive subject matter. In FIG. 28, a flow 2800 begins at block 2802.

At block 2802, an autonomous vehicle system receives a dispatch to a location. The location may be an event location as determined per FIG. 27. The flow continues at block 2804.

At block 2804, the autonomous vehicle maneuvers to the location. The flow continues at block 2806.

At block 2806, the autonomous vehicle determines whether the aerial autonomous vehicles are needed. The autonomous vehicle may make this determination based on the event type, an indication from the fleet controller, or other information received from the fleet controller or other sources. Some embodiments may perform computer vision processing on images captured by the video capture device 2210 to determine whether additional vantage points are needed. In some instances, the location may be remote from activities associated with the event. In such instances, the aerial autonomous vehicles would be needed to move closer to the activities. As an example, activities may be away from a roadway, so the aerial autonomous vehicles are necessary to move close enough to the activities for video capture. If the aerial autonomous vehicles are needed, the flow continues at block 2808. Otherwise, the flow continues at block 2810.

At block 2810, the land-based autonomous vehicle deploys the aerial autonomous vehicles. Deploying the aerial autonomous vehicles can include transmitting information about the event and video capture goals. The goals may differ for each of the aerial vehicles. The goals may include finding a particular object (person, animal, bicycle, car, etc.), capturing video from various enumerated perspectives (overhead, ground level, specified altitude, etc.), capturing video for a specified time duration, etc.

At block 2812, the autonomous vehicle system captures video of the event. If the aerial autonomous vehicles were deployed, they capture video along with the land-based autonomous vehicle. In some instances, the land-based vehicle may not capture video. In some instances, fewer than all the aerial vehicles are in position to capture video of interest, so only certain of the aerial vehicles may capture video. If the aerial autonomous vehicles were not deployed, the land-based autonomous vehicle captures the video. From block 2812, the flow ends.

In some embodiments, the operations of FIG. 26 are performed by components other than the fleet controller. For example, in some embodiments, the land-based autonomous vehicle (see FIG. 25) can perform one or more the operations described in FIG. 26. For example, the land-based autonomous vehicle can monitor the channel, determine the location, and proceed to the location for capturing video. In such embodiments, the land-based autonomous vehicle may include a communications monitoring unit similar to that shown in FIG. 18. In yet other embodiments, the operations shown in FIG. 26 may be performed by other components such as smart phone applications, personal computer applications, etc.

1. A method for providing control information to autonomous vehicles, the method comprising:
receiving a video content stream over an electronic communication interface;
identifying objects represented in the video content stream;
determining information about the objects; and
transmitting, to one or more autonomous vehicles, one or more data streams including the information about the objects.

2. The method of claim 1 further comprising:
capturing the video content stream with a video capture device.

3. The method of claim 2, wherein the video capture device is a video capture array.

4. The method of claim 3, wherein the video capture device is mounted on an aerial vehicle.

5. The method of claim 1, wherein the information about the objects indicates at least one of a location of the object, a direction the object is traveling, and a speed of the object.

6. A method for controlling, based on a control data stream, an autonomous vehicle in an area, the method comprising:
subscribing, by the autonomous vehicle, to a control stream derived from video image data and including information about objects in the area;
receiving the control stream over an electronic communications interface; and
controlling the autonomous vehicle to avoid the object based on the control stream.

7. The method of claim 6 wherein the video image data is captured by an aerial vehicle.

8. A method for deploying an autonomous vehicle system to capturing images about a location, the method comprising:
monitoring a communication channel for an indication of an event at a location;
dispatching an autonomous vehicle system to the location to capture video content of the location;
receiving, from the autonomous vehicle system, the video content captured via the autonomous vehicle system.

9. The method of claim 8 further comprising:
maneuvering, by a land-based autonomous vehicle, to the location; and
deploying, by the land-based autonomous vehicle, one or more aerial autonomous vehicles to capture the video content;
capturing, by at least one of the aerial autonomous vehicles, the video content;
transmitting, over the communication network, the video content.

10. The method of claim 8, where the autonomous vehicle system includes a land-based autonomous vehicle and one or more aerial autonomous vehicles.

11. The method of claim 10, wherein the aerial autonomous vehicles travel to the location on the land-based autonomous vehicle.

12. The method of claim 8, wherein the public radio channel is an emergency channel, and the event is an emergency situation described in an audio message transmitted over the communication channel.

13. The method of claim 8, wherein the communication channel is a public radio channel, and the event is an emergency described in an audio message transmitted over the communication channel.

14. The method of claim 8, wherein the video content includes motion picture video content.

15. The method of claim 8 further comprising:
receiving, over the communication channel, an audio message;
generating, based on the audio message, an electronic text message;
determining, based on the electronic text message, the event and a location.
